(19) United States
(12) Patent Application Publication
(10) Pub. No.: US 2010/0232342 A1
(43) Pub. Date: Sep. 16, 2010

(54) NODE DISCOVERY METHOD AND MOBILE NODE, RELAY NODE, HOME AGENT WHICH IS USED BY THE METHOD

(75) Inventors: Takako Hori, Kanagawa (JP); Toyoki Ue, Kanagawa (JP); Hong Cheng, Singapore (SG)

Correspondence Address: PEARNE & GORDON LLP, 1801 EAST 9TH STREET, SUITE 1200, CLEVELAND, OH, 44114-3108, US

(73) Assignee: PANASONIC CORPORATION, Osaka (JP)

(21) Appl. No.: 12/300,627

(22) PCT Filed: Jun. 1, 2007
(86) PCT No.: PCT/JP2007/061589

§ 371 Date: Nov. 12, 2008

(30) Foreign Application Priority Data
Jun. 2, 2006 (JP) 2006-155212
Oct. 31, 2006 (JP) 2006-297048

(51) Int. Cl. H04J 3/08

(52) U.S. Cl. 370/315

(57) ABSTRACT

There is disclosed a technique which provides a node discovery method and others capable of detecting a TA allowing a quasi-optimized data route for the achievement of a quasi-optimized data route while guarding the location privacy of an MN. This technique comprises a step in which a mobile node 101 transmits a first message, which is a message with a predetermined format, for the discovery of a processing node to a communication node 102, a step in which a relay node capable of processing the message with the predetermined format makes a judgment on the basis of the first message, received, as to whether the relay node itself is the processing node, and a step in which, when the judgment shows that the relay node itself is the processing node, the relay node which has made the judgment and which is capable of processing the message with the predetermined format transmits a second message, indicating that it becomes the processing node, to the mobile node.

### TECHNICAL FIELD

The present invention relates to node discovery method of discovering a node allowing a route approximate to an optimized route while guarding a location privacy, and mobile node, relay node and home agent, which are for use in this method.

### BACKGROUND ART

As techniques capable of providing a seamless connection with communication networks, even while moving, to a user who has access from a mobile node through wireless networks to communication networks such as the internet, technique utilizing the mobile IPv6 which is the next-generation internet protocol has come into widespread use. With reference to FIG. 16, a description will be given of an operation in a case in which both nodes which make communications are mobile nodes (MN: Mobile Node) supporting the mobile IPv6 and both the nodes (referred to as MN 1 and MN 2, respectively) exist in an external network. If each of the MN 1 and MN 2 does not know the CoA (Care of Address) the partner is using in the external network, as disclosed in the following Non-Patent Document 1, a packet is transmitted and received through a route 1 passing through an HA (Home Agent) 1 and an HA 2 as shown in FIG. 16. On the other hand, when each of the MN 1 and the MN 2 knows the partner's CoA, a packet to be sent from the MN 1 to the MN 2 is transmitted through an optimized route such as a route 2 shown in FIG. 16.

However, in the case of the employment of the optimized route, there is a need for the MN 1 to inform the MN 2 of the CoA it is using at present and for the MN 2 to inform the MN 1 of the CoA it is using at present. This leads to informing the partner of the current location. That is, this fails to guard the location privacy. For this reason, at present, in the IETF (Internet Engineering Task Force), a discussion is made about methods of securing a route (referred to as a quasi-optimized route) approximate to an optimized route while guarding a location privacy. As one of these methods, there is an ROTA (Route Optimization and location privacy using Tunneling Agent) disclosed in the following Non-Patent Document 2. The ROTA employs a node referred to as a tunneling agent (TA), and a quasi-optimized route is secured by shifting end point of the tunneling between MN and HA to this TA. The Non-Patent Document 2 shows two methods of selecting a TA. One is that one of the HAs of the MN 1 and the MN 2 is used as a TA as shown in FIG. 17a, the other is that, in a case in which a local HA and an MAP (Mobility Anchor Point), not shown, exists as shown in FIG. 17b, they are used as TA.

[Non-Patent Document 1] D. Johnson, C. Perkins and J. Arkko, “Mobility Support in IPv6”, RFC3775, June 2004

[Non-Patent Document 2] K. Weniger and T. Aramaki, “Route Optimization and Location Privacy using Tunneling Agent (ROTA)”, draft-weniger-rota-01, October 2005

[Non-Patent Document 3] R. Hancock (editor), G. Karagiannis, J. Loughney and S. Van den Bosch, “Next Steps in Signaling (NSIS): Framework”, RFC4080, June 2005

[Non-Patent Document 4] D. Johbson, S. Deering, “Reserved IPv6 Subnet Anycast Address”, RFC2526

However, in the case of, of the ROTA method, the method (FIG. 17a) of using HA as a TA, when the HA used as the TA exists at a position remote from the MN 1 or the MN 2, a route having highly quasi-optimized condition is unobtainable. Moreover, in the case of the method (FIG. 17b) of using a local HA or MAP as a TA, a local HA or MAP is not always found at destination of movement of MN and, if found, there is no guarantee that a TA function is in supported state.

### DISCLOSURE OF THE INVENTION

In consideration of the above-mentioned problems, it is an object of the present invention to, in the mobile IPv6, provide a node discovery method of detecting a TA capable of providing a quasi-optimized data route for the achievement of a quasi-optimized data route while guarding a location privacy of MN or detecting a TA capable of providing a more optimized data route, and mobile node, relay node and home agent, which are for use in this method.

For achieving this purpose, in accordance with the present invention, there is provided a node discovery method of, in a data communication system in which a mobile node which is connected to a first network and a communication node which is a communication partner of the mobile node and which is connected to a second network make communication with each other through a plurality of relay nodes located within an internetwork including the first network, the second network, a first home network which is a home network of the mobile node containing a home agent of the mobile node and a second home network which is a home network of the communication node containing home agent of the communication node, discovering a processing node which is, of the plurality of relay nodes, a relay node capable of processing a message with a predetermined format and positioned on a route through which a data packet to be transmitted from the mobile node to the communication node passes and adjacent to the communication node, comprising a step in which the mobile node transmits a first message, which is the message with the predetermined format, for the discovery of the processing node to the communication node, a step in which the relay node capable of processing the message with the predetermined format makes a judgment on the basis of the received first message as to whether it is the processing node, a step in which, when the judgment shows that the relay node itself is the processing node, the relay node which has made the judgment and which is capable of processing the message with the predetermined format transmits a second message, indicating that it becomes the processing node, to the mobile node. This arrangement enables detecting a TA allowing a quasi-optimized data route for the achievement of the quasi-optimized data route while guarding the location privacy of the mobile node (MN). The TA corresponds to the aforesaid processing node.

As a preferable mode of the present invention, in the node discovery method according to the present invention, the first message includes information for prompting the relay node capable of processing the message with the predetermined format to acquire the first message. This arrangement enables the relay node capable of processing the message with the predetermined format to intercept the first message.

In addition, as a preferable mode of the present invention, in the node discovery method according to the present invention, the mobile node transmits the first message through the home agent of the mobile node. This arrangement enables guarding the location privacy of the mobile node even in a case in which no relay node serving as a processing node exists between the mobile node and the communication node.

Still additionally, as a preferable mode of the present invention, in the node discovery method according to the present invention, the relay node capable of processing the message with the predetermined format receives the first message, the relay node converts the address of the source of the first message into its own address. This arrangement can guard the location privacy of the mobile node which is the source of the first message.

Yet additionally, as a preferable mode of the present invention, in the node discovery method according to the present invention, when the relay node capable of processing the message with the predetermined format receives the first message and makes a judgment as to whether or not the relay node itself is the processing node, it makes the judgment on the basis of information on an adjacent relay node capable of processing the message with the predetermined format, stored in its predetermined storage area, and information on the destination of the first message. This arrangement enables an accurate judgment as to whether or not this relay node itself is the processing node.

Furthermore, in accordance with the present invention, in a data communication system in which a mobile node which is connected to a first network and a communication node which is a communication partner of the mobile node and which is connected to a second network make communication with each other through a plurality of relay nodes located within an internetwork including the first network, the second network, a first home network which is a home network of the mobile node containing a home agent of the mobile node and a second home network which is a home network of the communication node containing a home agent of the communication node, there is provided a mobile node used for a node discovery method of discovering a processing node which is, of the plurality of relay nodes, a relay node capable of processing a message with a predetermined format and positioned on a route through which a data packet to be transmitted from the mobile node to the communication node passes and adjacent to the communication node, comprising message generating means for generating a first message which is the message with the predetermined format for discovering the processing node, transmission means for transmitting the generated first message to the communication node and reception means for receiving, from the relay node capable of processing the message with the predetermined format, judged as the processing node, a second message indicating that it becomes the processing node. This configuration enables detecting a TA providing a quasi-optimized data route for the accomplishment of the quasi-optimized data route while guarding the location privacy of the mobile node (MN).

Still furthermore, as a preferable mode of the present invention, in the mobile node according to the present invention, the message generating means puts, in the first message, information for prompting the relay node capable of processing the message with the predetermined format to acquire the first message. This configuration enables the relay node capable of processing the message with the predetermined format to intercept the first message.

Yet furthermore, as a preferable mode of the present invention, in the mobile node according to the present invention, the transmission means transmits the first message through the home agent of the mobile node. This configuration enables guarding the location privacy of the mobile node even in a case in which no relay node serving as a processing node exists between the mobile node and the communication node.

Moreover, in accordance with the present invention, in a data communication system in which a mobile node which is connected to a first network and a communication node which is a communication partner of the mobile node and which is connected to a second network make communication with each other through a plurality of relay nodes located within an internetwork including the first network, the second network, a first home network which is a home network of the mobile node containing a home agent of the mobile node and a second home network which is a home network of the communication node containing a home agent of the communication node, there is provided a relay node used for a node discovery method of discovering a processing node which is, of the plurality of relay nodes, a relay node capable of processing a message with a predetermined format and positioned on a route through which a data packet to be transmitted from the mobile node to the communication node passes and adjacent to the communication node, comprising reception means for receiving a first message serving as the message with the predetermined format for discovering the processing node, transmitted from the mobile node, judgment means for making a judgment on the basis of the received first message as to whether or not the relay node itself is the processing node, message generating means for, when the judgment shows that the relay node itself is the processing node, generating a second message indicative of the fact that it becomes the processing node and transmission means for transmitting the generated second message to the mobile node. This configuration enables detecting a TA providing a quasi-optimized data route for the accomplishment of the quasi-optimized data route while guarding the location privacy of the mobile node (MN).

Still moreover, as a preferable mode of the present invention, in the relay node according to the present invention, the first message includes information for prompting the relay node capable of processing the message with the predetermined format to acquire the first message. This arrangement enables the relay node capable of processing the message with the predetermined format to intercept the first message.

Yet moreover, as a preferable mode of the present invention, in the relay node according to the present invention, the judgment means converts the address of the source of the received first message into its own address. This configuration can guard the location privacy of the mobile node which is the source of the first message.

In addition, as a preferable mode of the present invention, in the relay node according to the present invention, when the judgment means makes a judgment as to whether or not the relay node itself is the processing node, it makes the judgment on the basis of information on an adjacent relay node capable of processing the message with the predetermined format, stored in its own predetermined storage area, and information on the destination of the first message. This arrangement enables an accurate judgment as to whether or not it is the processing node.

Furthermore, in accordance with the present invention, there is provided a node discovery method of, in a data communication system in which a mobile node which is connected to a first network and a communication node which is a communication partner of the mobile node and which is connected to a second network make communication with each other through a plurality of relay nodes located within an internetwork including the first network, the second network, a first home network which is a home network of the mobile node containing a home agent of the mobile node and a second home network which is a home network of the communication node containing a home agent of the communication node, discovering a processing node which is, of the plurality of relay nodes, a relay node capable of processing a message with a predetermined format and positioned on a route through which a data packet to be transmitted from the mobile node to the communication node passes, comprising a step in which the mobile node transmits, to a predetermined transmission destination, a first message, which is the message with the predetermined format for discovering said processing node and which includes predetermined hop information for setting, as said processing node, a relay node positioned at a predetermined hop destination on the route from said mobile node and capable of processing the message with the predetermined format, a step in which the relay node capable of processing the message with the predetermined format makes a judgment on the basis of the received first message as to whether or not the relay node itself is the processing node, and a step in which, when the judgment shows that the relay node itself is the processing node, the relay node capable of processing the message with the predetermined format, making the judgment transmits, to the mobile node, a second message indicating that it becomes the processing node. This arrangement enables detecting a TA providing a quasi-optimized data route for the achievement of the quasi-optimized data route while guarding the location privacy of the mobile node (MN).

Still furthermore, as a preferable mode of the present invention, in the node discovery method according to the present invention, the first message includes information for prompting the relay node capable of processing the message with the predetermined format to acquire the first message. This arrangement enables the relay node capable of processing the message with the predetermined format to intercept the first message.

Yet furthermore, as a preferable mode of the present invention, in the node discovery method according to the present invention, when the relay node capable of processing the message with the predetermined format receives the first message and makes a judgment that the relay node itself is not the processing node, the relay node transfers the first message in a state where the hop number indicative of the number of times of hop of the first message is incremented by 1. This arrangement enables the easy discovery of the processing node.

Moreover, as a preferable mode of the present invention, in the node discovery method according to the present invention, when the relay node capable of processing the message with the predetermined format receives the first message, the relay node makes a judgment on the basis of the hop number indicative of the number of times of hop of the first message and the predetermined hop information included in the first message as to whether or not the relay node itself is the processing node. This arrangement enables the accurate judgment as to whether or not it is the processing node.

Furthermore, in accordance with the present invention, in a data communication system in which a mobile node which is connected to a first network and a communication node which is a communication partner of the mobile node and which is connected to a second network make communication with each other through a plurality of relay nodes located within an internetwork including the first network, the second network, a first home network which is a home network of the mobile node containing a home agent of the mobile node and a second home network which is a home network of the communication node containing a home agent of the communication node, there is provided a mobile node used for a node discovery method of discovering a processing node which is, of the plurality of relay nodes, a relay node capable of processing a message with a predetermined format and positioned on a route through which a data packet to be transmitted from the mobile node to the communication node passes, comprising message generating means for generating a first message including predetermined hop information for setting, as the processing node, a relay node positioned at a predetermined hop destination on the route from the mobile node and capable of processing the message with the predetermined format for discovering the processing node, transmission means for transmitting the generated first message to a predetermined transmission destination and reception means for receiving, from the relay node capable of processing the message with the predetermined format, making the judgment that the relay node itself is the processing node, a second message indicating that it becomes the processing node. This configuration enables detecting a TA providing a quasi-optimized data route for the achievement of the quasi-optimized data route while guarding the location privacy of the mobile node (MN).

Still furthermore, as a preferable mode of the present invention, in the mobile node according to the present invention, the message generating means puts, in the first message, information for prompting the relay node capable of processing the message with the predetermined format to acquire the first message. This configuration enables the relay node capable of processing the message with the predetermined format to intercept the first message.

Moreover, in accordance with the present invention, in a data communication system in which a mobile node which is connected to a first network and a communication node which is a communication partner of the mobile node and which is connected to a second network make communication with each other through a plurality of relay nodes located within an internetwork including the first network, the second network, a first home network which is a home network of the mobile node containing a home agent of the mobile node and a second home network which is a home network of the communication node containing a home agent of the communication node, there is provided a relay node used for a node discovery method of discovering a processing node which is, of the plurality of relay nodes, a relay node capable of processing a message with a predetermined format and positioned on a route through which a data packet to be transmitted from the mobile node to the communication node passes, comprising reception means for receiving a first message which is the message with the predetermined format transmitted from the mobile node for discovering the processing node and which includes predetermined hop information for setting, as the processing node, a relay node positioned at a predetermined hop destination on the route from the mobile node and capable of processing the message with the predetermined format, judgment means for making a judgment on the basis of the received first message as to whether or not the relay node itself is the processing node, message generating means for, when the judgment shows that it is the processing node, generating a second message indicative of the fact that it becomes the processing node and transmission means for transmitting the generated second message to the mobile node. This configuration enables detecting a TA providing a quasi-optimized data route for the achievement of the quasi-optimized data route while guarding the location privacy of the mobile node (MN).

Still moreover, as a preferable mode of the present invention, in the relay node according to the present invention, the first message includes information for prompting the relay node capable of processing the message with the predetermined format to acquire the first message. This arrangement enables the relay node capable of processing the message with the predetermined format to intercept the first message.

Yet moreover, as a preferable mode of the present invention, in the relay node according to the present invention, when the judgment means makes a judgment that the relay node itself is not the processing node, the hop number indicative of the number of times of hop of the first message is incremented by 1. This arrangement enables the easy discovery of the processing node.

In addition, as a preferable mode of the present invention, in the relay node according to the present invention, the judgment means makes a judgment on the basis of the hop number indicative of the number of times of hop of the first message and the predetermined hop information included in the first message as to whether or not the relay node itself is the processing node. This configuration enables the accurate judgment as to whether or not it is the processing node.

Still additionally, as a preferable mode of the present invention, in the node discovery method according to the present invention, in a case in which the mobile node moves from the first network to establish a connection with a different network included in the internetwork, when a first route for the passage of the message with the predetermined format transmitted for discovering a processing node before the movement which is the processing node when the mobile node has been in connection with the first network before the movement intersects with a second route for the passage of the message with the predetermined format transmitted for discovering the processing node in the different network which is a new connection and the relay node capable of processing the message with the predetermined format immediately after convergence of the first route and the second route is positioned on the mobile node side with respect to the processing node before the movement on the route at the convergence, the processing node before the movement is continuously used as the processing node. This arrangement enables guarding the location privacy of the mobile node (MN).

Yet additionally, as a preferable mode of the present invention, in the mobile node according to the present invention, in a case in which the mobile node itself moves from the first network to establish a connection with a different network included in the internetwork, the reception means receives a message, indicating that a processing node before the movement which is the processing node discovered at the connection with the first network before the movement is to be continuously used as the processing node, from the relay node which is capable of processing the message with the predetermined format and which has received the message with the predetermined format transmitted from the transmission means for discovering the processing node in the different network which is a new connection and, the relay node is capable of processing the message with the predetermined format immediately after the convergence of the first route and the second route when a first route for the passage of the message with the predetermined format transmitted for discovering the processing node before the movement which is the processing node at the connection with the first network before the movement intersects with a second route for the passage of the message with the predetermined format transmitted for discovering the processing node in the different network which is a new connection, the judgment means determines, on the basis of the message received by the reception means, that the processing node before the movement is used as the processing node. This configuration enables guarding the location privacy of the mobile node (MN).

Moreover, as a preferable mode of the present invention, in the relay node according to the present invention, in a case in which the mobile node moves from the first network to establish a connection with a different network included in the internetwork, when a first route for the passage of the message with the predetermined format transmitted for discovering a processing node before the movement which is the processing node when the mobile node has been in connection with the first network before the movement intersects with a second route for the passage of the message with the predetermined format transmitted for discovering the processing node in the different network which is a new connection, the judgment means of the relay node capable of processing the message with the predetermined format immediately after the convergence of the first route and the second route makes a judgment as to whether or not the relay node is positioned on the mobile node side with respect to the processing node before the movement on the route at the convergence and, when the judgment in the judgment means shows that it is positioned on the mobile node side with respect to the processing node before the movement on the route at the convergence, the message generating means generates a message indicating that the processing node before the movement is to be continuously used as the processing node and the transmission means transmits the generated message to the mobile node. This configuration enables guarding the location privacy of the mobile node (MN).

Furthermore, in accordance with the present invention, there is provided a node discovery method of, in a data communication system in which a mobile node which is connected to a first network and a communication node which is a communication partner of the mobile node and which is connected to a second network make communication with each other through a plurality of relay nodes located within an internetwork including the first network, the second network, a first home network which is a home network of the mobile node containing a home agent of the mobile node and a second home network which is a home network of the communication node containing a home agent of the communication node, discovering a processing node which is, of the plurality of relay nodes, a relay node positioned on a direct path between the mobile node and the communication node, comprising a step in which the mobile node or a predetermined node in the first network, with which the mobile node is in connection, transmits the first message to the home agent of the communication node for making a request for discovering the processing node, a step in which, on the basis of received the first message, the home agent of the communication node transmits a second message for giving an instruction for initiating the discovery of the processing node to the communication node or a predetermined node in the second network with which the communication node is in connection, a step in which the communication node or the predetermined node in the second network with which the communication node is in connection transmits a third message for the discovery of the processing node on the basis of information included in the second message, a step in which the relay node which has received the third message makes a judgment on the basis of the third message as to whether or not the relay node itself is capable of becoming the processing node and, if capable, transmits information on this relay node itself to the home agent of the communication node, and a step in which the home agent of the communication node transmits the received information on this relay node capable of becoming the processing node to the mobile node or a predetermined node in the first network with which the mobile node is in connection. This configuration enables the detection of an TA providing a more optimized data route while guarding the location privacy of the MN.

Still furthermore, as a preferable mode of the present invention, in the node discovery method according to the present invention, the mobile node or the predetermined node in the first network with which the mobile node is in connection transmits the first message through the home agent of the mobile node to the home agent of the communication node. This configuration enables realizing it even if the route to the home agent of the communication node is in a disconnected state.

Yet furthermore, as a preferable mode of the present invention, in the node discovery method according to the present invention, in a case in which the relay node which has received the third message makes a judgment that the relay node itself is capable of becoming the processing node, when the relay node makes a judgment that a different node capable of becoming the processing node exists between this relay node itself and a node which is a destination of the third message, this relay node transfers the third message in a state where information on this relay node itself is appended thereto. This configuration enables broadening the options on the selection of the TA.

Moreover, as a preferable mode of the present invention, in the node discovery method according to the present invention, at the transmission of the second message, the home agent of the communication node transmits the second message, placed into an encapsulated state where the generated third message is inserted into the second message, to the communication node or the predetermined node in the second network with which the communication node is in connection and, at the transmission of the third message, the communication node or the predetermined node in the second network with which the communication node is in connection extracts the third message from the received encapsulated second message and transmits the third message on the basis of information included in the second message. This configuration enables reducing the load of the message generation in the communication node and others.

In addition, in accordance with the present invention, there is provided a node discovery method of, in a data communication system in which a mobile node which is connected to a first network and a communication node which is a communication partner of the mobile node and which is connected to a second network make communication with each other through a plurality of relay nodes located within an internetwork including the first network, the second network, a first home network which is a home network of the mobile node containing a home agent of the mobile node and a second home network which is a home network of the communication node containing a home agent of the communication node, discovering a processing node which is, of the plurality of relay nodes, a relay node positioned on a direct path between the mobile node and the communication node, comprising a step in which the mobile node or a predetermined node in the first network, with which the mobile node is in connection, transmits a message for the discovery of the processing node to the home agent of the communication node, a step in which the home agent of the communication node transfers the received message toward the communication node or a predetermined node in the second network with which the communication node is in connection, a step in which the communication node or the predetermined node in the second network with which the communication node is in connection transmits the received message on the basis of information included in the message, a step in which the relay node which has received the message makes a judgment on the basis of the message as to whether or not this relay node itself is capable of becoming the processing node and, if capable, transmits information on this relay node itself to the home agent of the communication node, and a step in which the home agent of the communication node transmits the received information on the relay node capable of becoming the processing node to the mobile node or the predetermined node in the first network with which the mobile node is in connection. This arrangement enables the detection of an TA providing a more optimized data route while guarding the location privacy of the MN.

Still additionally, as a preferable mode of the present invention, in the node discovery method according to the present invention, when the home agent of the communication node makes a judgment, on the basis of the received first message or the message, that the first network is the same as the second network, the home agent determines that the home agent itself becomes the processing node, or the home agent specifies a predetermined node as the processing node. This configuration enables avoiding a state where no optimized TA exists.

Furthermore, in accordance with the present invention, there is provided a node discovery method of, in a data communication system in which a mobile node which is connected to a first network and a communication node which is a communication partner of the mobile node and which is connected to a second network make communication with each other through a plurality of relay nodes located within an internetwork including the first network, the second network, a first home network which is a home network of the mobile node containing a home agent of the mobile node and a second home network which is a home network of the communication node containing a home agent of the communication node, discovering a processing node which is, of the plurality of relay nodes, a relay node positioned on a direct path between the mobile node and the communication node, comprising a step in which, when a direction of data traffic is from the mobile node to the communication node, the communication node or a predetermined node in the second network with which the communication node is in connection generates the first message on the basis of a fourth message indicative of a request for the initiation of the discovery of the processing node, received from the mobile node or a predetermined node in the first network with which the mobile node is in connection, and transmits the first message to the home agent of the mobile node, a step in which the home agent of the mobile node transmits a second message, indicating the initiation of the discovery of the processing node on the basis of the received first message, toward the mobile node or the predetermined node in the first network with which the mobile node is in connection, a step in which the mobile node or the predetermined node in the first network with which the mobile node is in connection transmits a third message for the discovery of the processing node on the basis of information included in the second message, a step in which the relay node which has received the third message makes a judgment on the basis of the third message as to whether or not the relay node itself is capable of becoming the processing node and, if capable, transmits information on this relay node itself to the home agent of the mobile node, and a step in which the home agent of the mobile node transmits the received information on the relay node capable of becoming the processing node to the communication node or the predetermined node in the second network with which the communication node is in connection. This arrangement enables the detection of a TA providing a more optimized data route while guarding the location privacy of an MN.

Still furthermore, as a preferable mode of the present invention, in the node discovery method according to the present invention, the mobile node or the predetermined node in the first network with which the mobile node is in connection transmits the plurality of first messages to a plurality of addresses. This arrangement enables preventing the assumption of the location of the mobile node.

Yet furthermore, as a preferable mode of the present invention, in the node discovery method according to the present invention, if the mobile node or the predetermined node in the first network with which the mobile node is in connection does not receive the information on the relay node capable of becoming the processing node from the home agent of the communication node, the mobile node or the predetermined node makes a communication through the home agent of the mobile node. This arrangement can prevent the selection of a TA which does not lie on an optimized route.

Moreover, in accordance with the present invention, in a data communication system in which a mobile node which is connected to a first network and a communication node which is a communication partner of the mobile node and which is connected to a second network make communication with each other through a plurality of relay nodes located within an internetwork including the first network, the second network, a first home network which is a home network of the mobile node containing a home agent of the mobile node and a second home network which is a home network of the communication node containing a home agent of the communication node, there is provided the mobile node used for a node discovery method of discovering a processing node which is, of the plurality of relay nodes, a relay node positioned on a direct path between the mobile node and the communication node, comprising message generating means for generating a first message for making a request for the discovery of the processing node and transmission means for transmitting the generated first message to the home agent of the communication node. This configuration enables the detection of a TA providing a more optimized data route while guarding the location privacy of an MN.

Still moreover, as a preferable mode of the present invention, in the mobile node according to the present invention, the transmission means transmits the first message through the home agent of the mobile node to the home agent of the communication node. This configuration enables realizing it even if the route to the home agent of the communication node is in a disconnected state.

In addition, in accordance with the present invention, in a data communication system in which a mobile node which is connected to a first network and a communication node which is a communication partner of the mobile node and which is connected to a second network make communication with each other through a plurality of relay nodes located within an internetwork including the first network, the second network, a first home network which is a home network of the mobile node containing a home agent of the mobile node and a second home network which is a home network of the communication node containing a home agent of the communication node, there is provided the mobile node used for a node discovery method of discovering a processing node which is, of the plurality of relay nodes, a relay node positioned on a direct path between the mobile node and the communication node, comprising message generating means for generating a message for the discovery of the processing node and transmission means for transmitting the generated message to the home agent of the communication node. This configuration enables the detection of a TA providing a more optimized data route while guarding the location privacy of an MN.

Still additionally, in accordance with the present invention, in a data communication system in which a mobile node which is connected to a first network and a communication node which is a communication partner of the mobile node and which is connected to a second network make communication with each other through a plurality of relay nodes located within an internetwork including the first network, the second network, a first home network which is a home network of the mobile node containing a home agent of the mobile node and a second home network which is a home network of the communication node containing a home agent of the communication node, there is provided the mobile node used for a node discovery method of discovering a processing node which is, of the plurality of relay nodes, a relay node positioned on a direct path between the mobile node and the communication node, comprising message generating means for, when a direction of data traffic is from the mobile node to the communication node, generating a message for making a request for the initiation of the discovery of the processing node and transmission means for transmitting the generated message to the communication node or a predetermined node in the second network with which the communication node is in connection. This configuration enables the detection of a TA allowing a more optimized data route while guarding the location privacy of an MN.

Yet additionally, as a preferable mode of the present invention, in the mobile node according to the present invention, the message generating means generates the plurality of first messages and the transmission means transmits the plurality of generated first messages to a plurality of addresses. This arrangement enables preventing the assumption of the location of the mobile node.

Moreover, as a preferable mode of the present invention, in the mobile node according to the present invention, in the case of no reception of the information on the relay node capable of becoming the processing node from the home agent of the communication node, the transmission means makes a communication through the home agent of the mobile node. This arrangement can prevent the selection of a TA which does not lie on an optimized route.

In addition, in accordance with the present invention, in a data communication system in which a mobile node which is connected to a first network and a communication node which is a communication partner of the mobile node and which is connected to a second network make communication with each other through a plurality of relay nodes located within an internetwork including the first network, the second network, a first home network which is a home network of the mobile node containing a home agent of the mobile node and a second home network which is a home network of the communication node containing a home agent of the communication node, there is provided the home agent of the communication node used for a node discovery method of discovering a processing node which is, of the plurality of relay nodes, a relay node positioned on a direct path between the mobile node and the communication node, comprising reception means for receiving a first message for making a request for the discovery of the processing node, transmitted from the mobile node or a predetermined node in the first network with which the mobile node is in connection, message generating means for generating a second message indicating the initiation of the discovery of the processing node on the basis of the received first message, and transmission means for transmitting the generated second message toward the communication node or a predetermined node in the second network with which the communication node is in connection, wherein the transmission means transmits the information on the relay node capable of becoming the processing node, received through the reception means, to the mobile node or the predetermined node in the first network with which the mobile node is in connection. This configuration enables the detection of a TA allowing a more optimized data route while guarding the location privacy of an MN.

Still additionally, as a preferable mode of the present invention, in the home agent according to the present invention, at the transmission of the second message, the transmission means transmits the second message placed into an encapsulated state where a third message for the discovery of the processing node, generated by the message generating means, is inserted into the second message toward the communication node or the predetermined node in the second network with which the communication node is in communication. This configuration enables reducing the load of the message generation in the communication node and others.

Moreover, in accordance with the present invention, in a data communication system in which a mobile node which is connected to a first network and a communication node which is a communication partner of the mobile node and which is connected to a second network make communication with each other through a plurality of relay nodes located within an internetwork including the first network, the second network, a first home network which is a home network of the mobile node containing a home agent of the mobile node and a second home network which is a home network of the communication node containing a home agent of the communication node, there is provided the home agent of the communication node used for a node discovery method of discovering a processing node which is, of the plurality of relay nodes, a relay node positioned on a direct path between the mobile node and the communication node, comprising reception means for receiving a message for the discovery of the processing node transmitted from the mobile node or a predetermined node in the first network with which the mobile node is in connection and the transmission means for transferring the received message toward the communication node or a predetermined node in the second network with the communication node is in connection, wherein the transmission means transmits the information on the relay node capable of becoming the processing node, received through the reception means, to the mobile node or the predetermined node in the first network with which the mobile node is in connection. This configuration enables the detection of a TA providing a more optimized data route while guarding the location privacy of an MN.

Still moreover, as a preferable mode of the present invention, the home agent according to the present invention further comprises judgment means for making a judgment on the basis of the received first message or message as to whether or not the first network is the same as the second network and, if the judgment in the judgment means shows that the first network is the same as the second network, determines that it becomes the processing node or specifies the predetermined node as the processing node. This configuration enables avoiding a state where no optimized TA exists.

Furthermore, in accordance with the present invention, in a data communication system in which a mobile node which is connected to a first network and a communication node which is a communication partner of the mobile node and which is connected to a second network make communication with each other through a plurality of relay nodes located within an internetwork including the first network, the second network, a first home network which is a home network of the mobile node containing a home agent of the mobile node and a second home network which is a home network of the communication node containing a home agent of the communication node, there is provided the relay node used for a node discovery method of discovering a processing node which is, of the plurality of relay nodes, a relay node positioned on a direct path between the mobile node and the communication node, comprising reception means for receiving a message for the discovery of the processing node from the communication node or a predetermined node in the second network with which the communication node is in connection, judgment means for making a judgment on the basis of the received message as to whether or not the replay node itself is capable of becoming the processing node, and transmission means for, when the judgment shows that it is capable of becoming the processing node, transmitting information on this relay node itself to the home agent of the communication node. This configuration enables the detection of a TA providing a more optimized data route while guarding the location privacy of an MN.

Still furthermore, as a preferable mode of the present invention, in the relay node according to the present invention, in a case in which the judgment in the judgment means shows that the relay node itself is capable of becoming the processing node and when the judgment means makes a judgment as to whether or not a different node capable of becoming the processing node exists between this relay node itself and a node which is a destination of the message and judges that it exists, the transmission means adds the information thereon to the message and transfers the message. This configuration enables broadening the options on the selection of the TA.

Moreover, in accordance with the present invention, in a data communication system in which a mobile node which is connected to a first network and a communication node which is a communication partner of the mobile node and which is connected to a second network make communication with each other through a plurality of relay nodes located within an internetwork including the first network, the second network, a first home network which is a home network of the mobile node containing a home agent of the mobile node and a second home network which is a home network of the communication node containing a home agent of the communication node, there is provided the relay node used for a node discovery method of discovering a processing node which is, of the plurality of relay nodes, a relay node positioned on a direct path between the mobile node and the communication node, comprising reception means for, when a direction of data traffic is from the mobile node to the communication node, receiving a third message for the discovery of the processing node from the mobile node or a predetermined node in the first network with which the mobile node is in connection, judgment means for making a judgment on the basis of the received third message as to whether or not the relay node itself is capable of becoming the processing node, and transmission means for, when the judgment shows that it is capable of becoming the processing node, transmitting information on this relay node itself to the home agent of the mobile node. This configuration enables the detection of a TA providing a more optimized data route while guarding the location privacy of an MN.

According to the present invention, the node discovery method, and the mobile node, relay node and home agent used for this method have the above-described arrangement/configuration and, in the mobile IPv6, enable detecting a TA, which can provide a quasi-optimized data route for the accomplishment of a quasi-optimized data route, while guarding the location privacy of MN and further enable the detection of a TA providing a more optimized data route.

### BRIEF DESCRIPTION OF THE DRAWINGS

FIG. 1 is a block diagram showing one example of a configuration of a data communication system according to a first embodiment of the present invention;

FIG. 2 is a block diagram showing one example of an arrangement of a TA NSIS protocol according to the first embodiment of the present invention;

FIG. 3 is a sequence chart for explaining one example of a TA retrieval sequence according to the first embodiment of the present invention;

FIG. 4 is a block diagram showing one example of a configuration of a mobile node (MN) according to the first embodiment of the present invention;

FIG. 5 is a block diagram showing one example of a configuration of a relay node (TAE) according to the first embodiment of the present invention;

FIG. 6 is a block diagram showing one example of a configuration of a data communication system according to a second embodiment of the present invention;

FIG. 7 is a sequence chart for explaining one example of a TA retrieval sequence according to the second embodiment of the present invention;

FIG. 8 is a block diagram showing one example of a configuration of a mobile node (MN) according to the second embodiment of the present invention;

FIG. 9 is a block diagram showing one example of a configuration of a relay node (TAE) according to the second embodiment of the present invention;

FIG. 10 is a block diagram showing one example of a configuration of a data communication system according to a third embodiment of the present invention;

FIG. 11 is a block diagram showing one example of a configuration of a data communication system according to fourth to eighth embodiments of the present invention;

FIG. 12 is a sequence chart showing one example of a sequence for discovery of a TA according to the fourth embodiment of the present invention;

FIG. 13 is a flow chart showing one example of message processing in an HA according to the fourth embodiment of the present invention;

FIG. 14 is a flow chart showing one example of message processing in an HA according to the fourth embodiment of the present invention;

FIG. 15 is a flow chart showing one example of a TA-Disc message processing flow in a relay node according to the fourth embodiment of the present invention;

FIG. 16 is an illustration for explaining transmission/reception of a packet in a conventional data communication system;

FIG. 17a is an illustration for explaining a conventional method of determining a TA; and

FIG. 17b is an illustration for explaining a conventional different method of determining a TA.

### BEST MODE FOR CARRYING OUT THE INVENTION

### First Embodiment

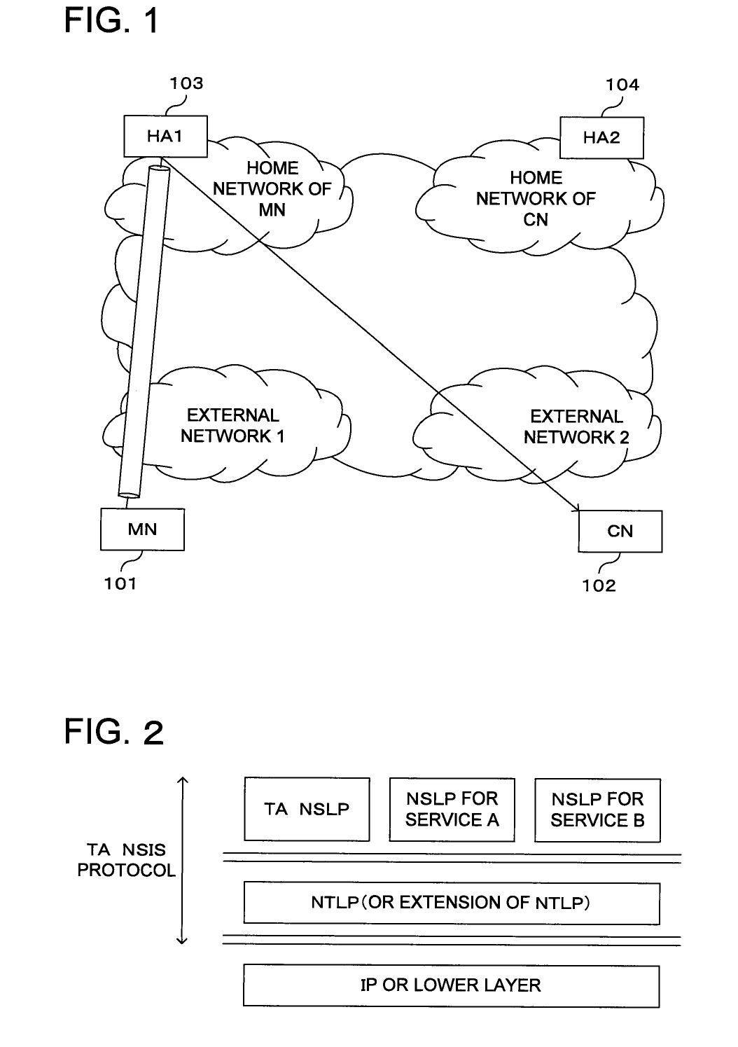

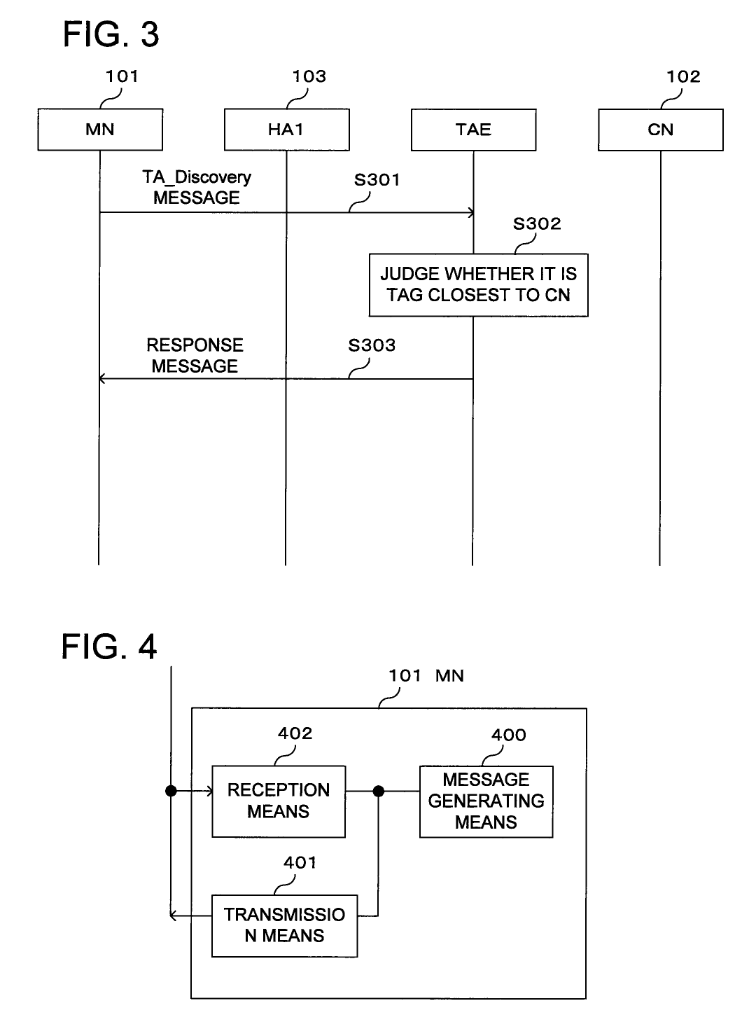

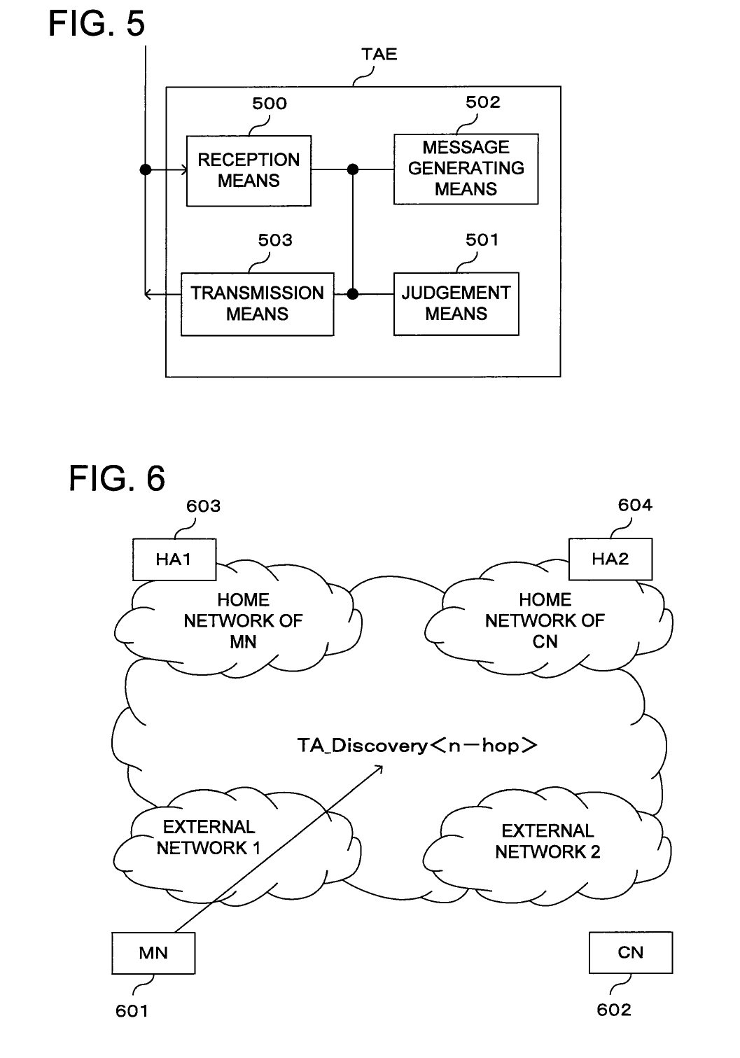

A first embodiment of the present invention will be described hereinbelow with reference to FIGS. 1 to 5. FIG. 1 is a block diagram showing one example of a configuration of a data communication system according to a first embodiment of the present invention. FIG. 2 is a block diagram showing one example of an arrangement of a TA NSIS protocol according to the first embodiment of the present invention. FIG. 3 is a sequence chart for explaining one example of a TA retrieval sequence according to the first embodiment of the present invention. FIG. 4 is a block diagram showing one example of a configuration of a mobile node (MN) according to the first embodiment of the present invention. FIG. 5 is a block diagram showing one example of a configuration of a relay node (TAE) according to the first embodiment of the present invention.

In the present invention, nodes having a TA function are located in the internetwork and a TA (corresponding to the above-mentioned processing node) which provides a quasi-optimized route is detected through the use of a signaling message. The node having the TA function contains a protocol having a function to process and execute a signaling message for the TA detection and a function to set a TA. This protocol is an extension of the NSIS protocol disclosed in the aforesaid Non-Patent Document 3, and in the present invention, it will be referred to as a TA NSIS protocol. FIG. 2 is an illustration of an arrangement of the TA NSIS protocol. As well as the NSIS protocol, the TA NSIS protocol is a protocol in the transport layer and is composed of two layers of an NTLP (NSIS Transport Layer Protocol) or an extension thereof and NSLP (NSIS Signaling Layer Protocol). The TANSIS protocol particularly has a TA NSLP in the NSLP layer. In the present invention, a function capable of executing the TANSIS protocol in a node having a TA function will be referred to as a TAE (TAEntity). Moreover, in the present invention, a node itself having the TA function will sometimes be referred to as a TAE.

Referring to FIG. 1, a description will be given hereinbelow of a first embodiment of the present invention. MN 101 is a mobile node supporting the mobile IPv6, and HA 1 (103) is a home agent. CN 102 is a mobile node supporting the mobile IPv6 or a node supporting the IPv6 (not supporting the mobile IPv6), and in the case of supporting the mobile IPv6, HA 2 (104) is set as a home agent. Now, let it be assumed that the MN 101 knows a CoA of the CN 102 (the IP address of the CN 102 in a case in which the CN 102 does not support the mobile IPv6; herein after referred as a CoA) and the MN 101 transmits a data packet through the HA 1 (103) to the CoA of the CN 102 through the use of its own HoA (Home address).

In this case, the MN 101 initiates a TA retrieval for transmitting a data packet to the CN 102 through the use of a quasi-optimized route while concealing its own CoA. As the TA, there is selected a TAE closest to the CN 102 on the TA retrieval route. Referring to FIG. 3, a description will be given of one example of a sequence for the TA retrieval.

First of all, the MN 101 transmits a TA_Discovery message (corresponding to the above-mentioned first message) to the CoA of the CN 102 in a state where its own HoA is set as a source address (step S301). That is, it is transmitted through the HA 1 (103) to the CN 102. The TA_Discovery message is a TANSLP message (corresponding to the above-mentioned message with the predetermined format) and, as well as the other NSIS NSLP messages, RAO (Route Alert Option; corresponding to the above-mentioned information for prompting to acquire the first message) is added thereto, thereby accomplishing the intercepting by each TAE lying on a route through which the TA_Discovery message passes. As well as the normal NSIS Entity operation, each TAE which has intercepted the TA_Discovery message can store, in addition to information (session identifier or the like) serving as a key of the TA_Discovery message, information on adjacent TAEs in an upstream direction and in a downstream direction. Each TAE makes a comparison with respect to the adjacent TAE in the downstream direction and destination address (CoA of the CN 102), stored, thereby making a judgment as to whether it is a TAE closest to the CN 102 (step S302).

As the judgment way, there are two methods: a case in which the CN 102 itself is a TAE and a case in which the CN 102 does not have a TAE function. In the former case, the CN 102 itself, serving as a TAE, is a TAE closest to the CN 102 while, in the latter case, the last (no adjacent TAE exists in the downstream direction) TAE on the route is a TAE closest to the CN 102. The TAE closest to the CN 102 returns a response message (corresponding to the above-mentioned second message) to the TA_Discovery message to the MN 101 (step S303), thereby declaring that it becomes a TA. As mentioned above, by the transmission through the HA 1 (103), it is possible to prevent the CN 102 from realizing the source of the TA_Discovery message, thus preventing the location of the MN 101 from being known.

In this connection, it is also possible that the MN 101 transmits the TA_Discovery message directly to the CN 102 without passing through the HA 1 (103) in a state where its own CoA is set as the source address. However, in a case in which no TAE exists between the MN 101 and the CN 102, there is a possibility that the CN 102 can know the CoA of the MN 101 and realize the location thereof. For this reason, for preventing the CN 102 from knowing the CoA of the MN 101, there is a need to carry out the processing in which each TAE which has intercepted the TA_Discovery message rewrites the source address into its own address.

As mentioned above, upon the determination of a TA, the transmission/reception of a data packet is made between the MN 101 and the CN 102. A description will be given here of a case in which a data packet is transmitted from the CN 102 to the MN 101. In the case of the transmission of a data packet from the CN 102 to the MN 101, when the MN 101 and the determined TA are in one-to-one correspondence, the data packet can easily be transferred to the MN 100 by the TA. However, if the MN 101 and the TA are not in one-to-one correspondence, the TA need to distribute the data packet from the CN 102. Incidentally, it is also appropriate that the CN 102 is made to transmit the data packet through the HA 1 (103) to the MN 101.

Referring to FIG. 4, a description will be given hereinbelow of one example of a mobile node (MN) according to the first embodiment of the present invention. As shown in FIG. 4, the MN 101 is composed of a message generating means 400, a transmission means 401 and a reception means 402. The message generating means 400 is for generating a TA_Discovery message which is a message with a predetermined format for the discovery of a TA. Moreover, at the generation of the TA_Discovery message, the message generating means 400 appends the above-mentioned RAO to the TA_Discovery message.

The transmission means 401 is for transmitting the generated TA_Discovery message to the correspondent node (CN 102). It is also acceptable that the transmission means 401 transmits the generated TA_Discovery message through the HA 1 (103) without transmitting it directly to the CN 102. In the case of the transmission through the HA 1 (103), it is possible to reliably guard the location privacy of the MN 101. The reception means 402 is for receiving, from a relay node (TAE) capable of processing a message with a predetermined format judging that it is a TA, a response message indicative of it becoming a TA.

Furthermore, referring to FIG. 5, a description will be given hereinbelow of one example of a relay node (TAE) according to the first embodiment of the present invention. As shown in FIG. 5, a TAE is composed of a reception means 500, a judgment means 501, a message generating means 502 and a transmission means 503. The reception means 500 is for receiving the TA_Discovery message for the discovery of a TA transmitted from the MN 101. The judgment means 501 is making a judgment on the basis of the TA_Discovery message received by the reception means 500 as to whether or not it is a TA. Concretely, the judgment means 501 makes a comparison with respect to the stored adjacent TAEs in the downstream direction and the address of the source (CoA of the CN 102) as mentioned above so as to make a judgment as to whether or not it is the TAE closest to the CN 102.

In addition, in a case in which the TA_Discovery message, received, is not transmitted through the HA 1 (103) to the CN 102, the judgment means 501 carries out the processing to convert the source address of the received TA_Discovery message into its own address. Thus, the CN 102 cannot realize that the source of the TA_Discovery message is the MN 101, which leads to guarding the location privacy of the MN 101 from the CN 102. In a case in which the TA_Discovery message is transmitted through the HA 1 (103) to the CN 102, it is not always necessary to convert the source address of the received TA_Discovery message into its own address. This is because the TA_Discovery message is through the HA 1 (103) and the source of the TA_Discovery message is the HoA of the MN 101, which enables guarding the location privacy of the MN 101. The message generating means 502 is for, when the judgment shows that it is a TA, generating a response message indicative of it becoming the TA. The transmission means 503 is for transmitting the response message generated by the message generating means 502 to the MN 101.

### Second Embodiment

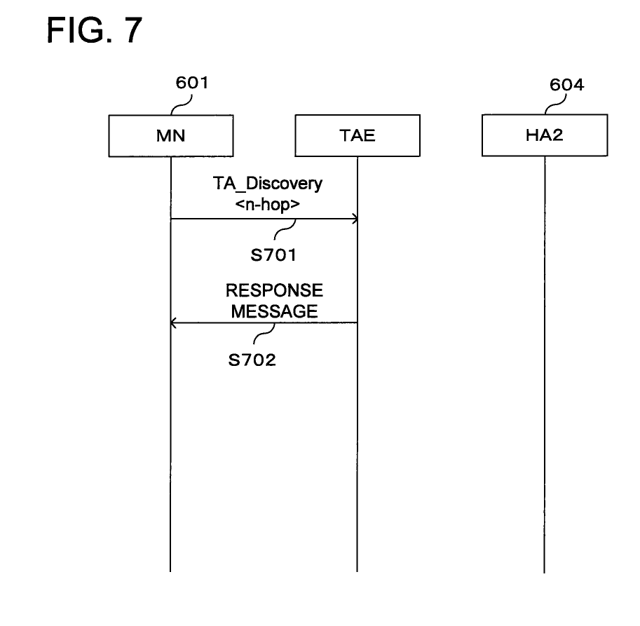

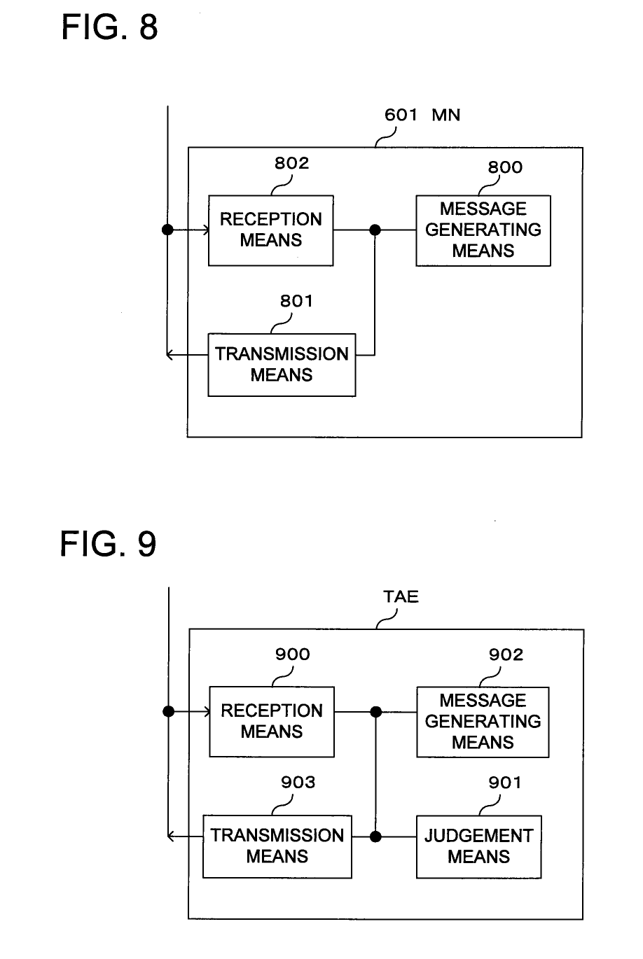

With reference to FIGS. 6 to 9, a description will be given hereinbelow of a second embodiment of the present invention. FIG. 6 is a block diagram showing one example of a configuration of a data communication system according to a second embodiment of the present invention. FIG. 7 is a sequence chart for explaining one example of a TA retrieval sequence according to the second embodiment of the present invention. FIG. 8 is a block diagram showing one example of a configuration of a mobile node (MN) according to the second embodiment of the present invention. FIG. 9 is a block diagram showing one example of a configuration of a relay node (TAE) according to the second embodiment of the present invention.

The second embodiment of the present invention will be described with reference to FIG. 6. MN 601 and CN 602 are a mobile node supporting the mobile IPv6 and employ an HA 1 (603) and HA 2 (604) as home agents, respectively. Now, let it be assumed that the MN 601 and the 602 do not mutually know their CoAs and the MN 601 is transmitting data from its own HoA to the HoA of the CN 602. In this case, the MN 601 initiates a TA retrieval for transmitting the data to the CN 602 through the use of a quasi-optimized route while concealing its own CoA. Since the MN 601 does not know the CoA of the CN 602, an arbitrary TAE is set as a TA. Referring to FIG. 7, a description will be given of one example of a TA retrieval sequence in this case.

The MN 601 transmits a TA_Discovery <n-hop> message to an arbitrary address, such as the HoA of the CN 602 (step S701). The TA_Discovery <n-hop> message signifies that the TA_Discovery message is sent up to the n-th TAE and this n-th TAE is set as a TA. For example, in the case of a TA_Discovery <2-hop> message, the second TAE ahead of the MN 601 which is the source receives the TA_Discovery <2-hop> message and is set as a TA. In a case in which no n TAEs exists between the source and an arbitrary destination, a TAE which becomes a destination receives it (if the destination is not a TAE, a TAE closest to the destination). In the case of this example, the HA 2 (604) becomes a TA. Moreover, it is also appropriate that the MN 601 previously acquires the address of the HA 2 (604) and transmits the TA_Discovery <n-hop> message.

In addition, it is also appropriate that the MN 601 appends, to the TA_Discovery <n-hop> message, a hop counter indicative of the number of times of hop of the TA_Discovery <n-hop> message. Thus, when the TAE which has received the TA_Discovery <n-hop> message makes a judgment that it is not a TA, this TAE increments the hop counter by 1 and transfers it. In this way, the TAE corresponding to the timing that the value of n of the TA_Discovery <n-hop> message becomes equal to the value of the hop counter can be set as a TA, which enables easy discovery of the TA. In a case in which the TAE which has received the TA_Discovery <n-hop> makes a judgment that it is a TA, this TAE returns a response message corresponding to the TA_Discovery <n-hop> to the MN 601 (step S702) to declaring that it becomes the TA.

Preferably, when the MN 601 transmits the TA_Discovery <n-hop> to an arbitrary address, the MN 601 secures the security on the mobile IPv6 with respect to the destination, that is, it is preferable for RR (Return Rout ability) to be completed. For example, it is preferable that, when the HA 2 (604) is set as the destination, it completes the RR relative to the HA 2 (604) and then the TA_Discovery <n-hop> is sent.

Secondly, referring to FIG. 8, a description will be given hereinbelow of one example of a mobile node (MN) according to the second embodiment of the present invention. As shown in FIG. 8, the MN 601 is made up of a message generating means 800, a transmission means 801 and a reception means 802. The message generating means 800 is for generating a TA_Discovery <n-hop> message for the discovery of a TA. The TA_Discovery <n-hop> message includes predetermined hop information for setting, as a TA, a relay node. The relay node can process the TA_Discovery <n-hop> message and locates in a predetermined hop destination on a route through which a data packet to be transmitted from the MN 601 to the CN 602 passes. As mentioned above, it is also appropriate that the message generating means 800 appends, to the TA_Discovery <n-hop> message, a hop counter indicative of the number of times of hop of the TA_Discovery <n-hop> message. Moreover, as well as the first embodiment, it is also appropriate that the message generating means 800 appends RAO to the TA_Discovery <n-hop> message at the generation of the TA_Discovery <n-hop> message.

The transmission means 801 is for transmitting the TA_Discovery <n-hop> message generated by the message generating means 800 to a predetermined destination address. In this case, the predetermined destination address signifies, for example, the HoA of the CN 602 or the like as mentioned above. The reception means 802 is for receiving a response message indicative of it becoming a TA from a relay node (TAE) which makes a judgment that it is the TA and which is capable of processing a message with a predetermined format.

Furthermore, referring to FIG. 9, a description will be given hereinbelow of one example of a relay node (TAE) according to the second embodiment of the present invention. As shown in FIG. 9, the TAE is made up of a reception means 900, a judgment means 901, a message generating means 902 and a transmission means 903. The reception means 900 is for receiving a TA_Discovery <n-hop> message for the discovery of a TA transmitted from the MN 601. The TA_Discovery <n-hop> message includes predetermined hop information for setting, as a TA, a relay node which can process the TA_Discovery <n-hop> message and locates in the predetermined hop destination on a route through which a data packet to be transmitted from the MN 601 to the CN 602 passes.

The judgment means 901 is for making a judgment on the basis of the received TA_Discovery <n-hop> message as to whether or not it is a TA. Concretely, the judgment means 901 makes a judgment as to whether or not the value of the hop counter added to the TA_Discovery <n-hop> message is equal to the value of n of the TA_Discovery <n-hop> message and, if the values are equal to each other, judges that it is a TA. When the judgment means 901 makes a judgment that it is not a TA, the judgment means 901 adds 1 to value of the hop counter added to the TA_Discovery <n-hop> message.

The message generating means 902 is for, when the judgment means 901 makes a judgment that it is a TA, generating a response message indicative of it being the TA. The transmission means 903 is for transmitting the generated response message to the MN 601 or for transferring the TA_Discovery <n-hop> message in which 1 is added to the value of the hop counter.

### Third Embodiment

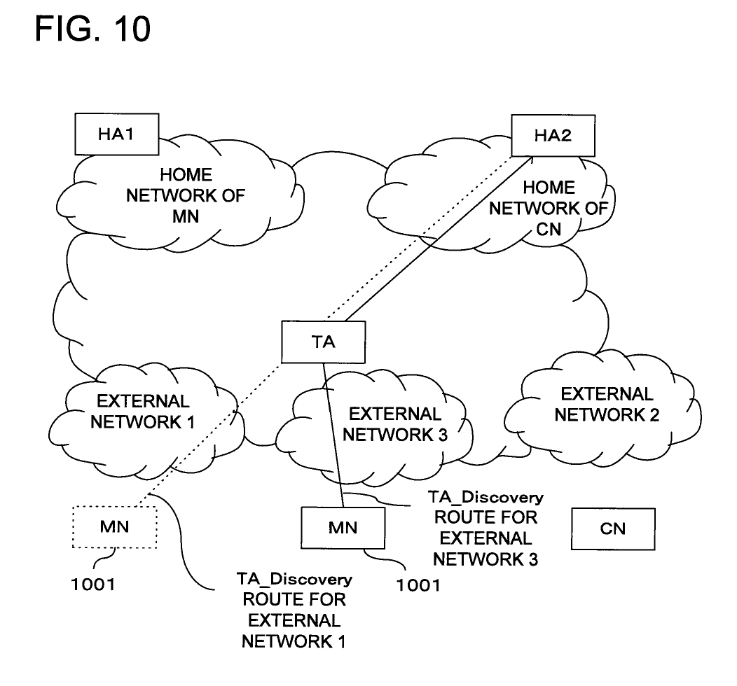

Referring to FIG. 10, a description will be given hereinbelow of a case in which, in the first embodiment and the second embodiment, MN has moved to a different network. Let it be assumed that MN 1001 moves from an external network 1 to an external network 3. At this time, the MN 1001 again transmits a TA_Discovery message or TA_Discovery <n-hop> message (which will herein after be referred to simply as a TA_Discovery message) according to the method according to the first or second embodiment. In this case, a route used at the transmission of the TA_Discovery message in the external network 1 intersects with a route used for the transmission of the TA_Discovery message in the external network 3 and, in a case in which the first TAE (Crossover TAE) on the converged route exists short of a TA (which will herein after be referred to as current TA) the MN 1001 has used in the external network 1, that is, when it lies on the MN 1001 side, the MN 1001 continuously uses the current TA even in the external network 3.

As a method of detecting the positional relationship between the Crossover TAE and the current TA, for example, in a case in which MN 1001 transmits a TA_Discovery message in the external network 3, if the current TA intercepts this TA_Discovery message, it returns a response message corresponding to the TA_Discovery message to the MN 1001, thereby declaring that it is the TA. If the current TA does not intercept the TA_Discovery message, that is, when the current TA does not exists on the route of the TA_Discovery message in the external network 3, a new TA is selected according to the method in the first embodiment or the second embodiment.

In addition, As another method of detecting the positional relationship between the Crossover TAE and the current TA, when a TA is selected through the use of a TA_Discovery message, the TA determination is previously notified to all the TAEs existing up to the TA selected by the MN 1001. Moreover, in a case in which the MN 1001 transmits the TA_Discovery message in the external network 3, when the Crossover TAE detects that it exists on the MN 1001 side with respect to the current TA, it stops the transfer of the TA_Discovery message and transmits a message to the effect that “continue to use the current TA” to the MN 1001. If the Crossover TAE does not exist on the MN 1001 side with respect to the current TA, the TA_Discovery message is continuously transferred and a new TA is determined. For the notification of the determination of the TA to the TAEs existing between the MN 1001 and the TA, for example, it is possible that the TA makes the notification at the return of a response message corresponding to the TA_Discovery message. This is because, when the NSIS method is taken, the response message passes through the exact opposite route to the TA_Discovery message and all the TAEs existing between the MN 1001 and the TA can receive the response message.

Incidentally, since the implementation of the above-described TA discovery processing at every movement of the MN 1001 creates a problem in that a processing load increases or causes other problems, it is also acceptable to keep the TA used before the movement even at the movement destination without conducting the TA discovery processing.

A description will be given hereinbelow of one example of processing in the MN 1001 according to the third embodiment. As mentioned above, let it be assumed that the MN 1001 moves from the external network 1 and then establishes a connection with the external network 3. With respect to a TAE which has received a TA_Discovery message transmitted from a transmission means, not shown, for the discovery of a TA in the new connection-accepting side external network 3, in a state where a first route (TA_Discovery route in the external network 1 shown in FIG. 10) through which the TA_Discovery message transmitted for the discovery of the TA at the connection with the external network 1 before the movement passes intersects with a second route (TA_Discovery route in the external network 3 shown in FIG. 10) through which a TA_Discovery message transmitted for the discovery of a TA in the new connection-accepting side external network 3 passes, when a not-shown reception means of the MN 1001 receives a message, to the effect that the TA discovered at the connection with the external network 1 before the movement is to be continuously used as a processing node, from the not-shown TAE immediately after the convergence between the first route and the second route, a not-shown judgment of the MN 1001 determines, on the basis of the message received by the non-shown reception means, that the TA before the movement is continuously used as the processing node.

Furthermore, a description will be given hereinbelow of one example of processing in a Crossover TAE according to the third embodiment. As mentioned above, let it be assumed that the MN 1001 moves from the external network 1 and then establishes a connection with the external network 3. In a state where a first route (TA_Discovery route in the external network 1 shown in FIG. 10) through which the TA_Discovery message transmitted for the discovery of the TA at the connection with the external network 1 before the movement passes intersects with a second route (TA_Discovery route in the external network 3 shown in FIG. 10) through which a TA_Discovery message transmitted for the discovery of a TA in the new connection-accepting side external network 3 passes, a judgment means of a not-shown TAE immediately after the convergence of the first route and the second route makes a judgment as to whether or not it is positioned on the MN 1001 side with respect to a TA in the external network 1 on the convergence route, and when the judgment in the judgment means of the not-shown TAE shows that it is positioned on the MN 1001 side with respect to the TA in the external network 1 on the convergence route, a message generating means of the not-shown TAE generates a message to the effect that the TA in the external network 1 is to be continuously used as a TA, and a transmission means of the not-shown TAE transmits the generated message to the MN 1001.

### Fourth Embodiment

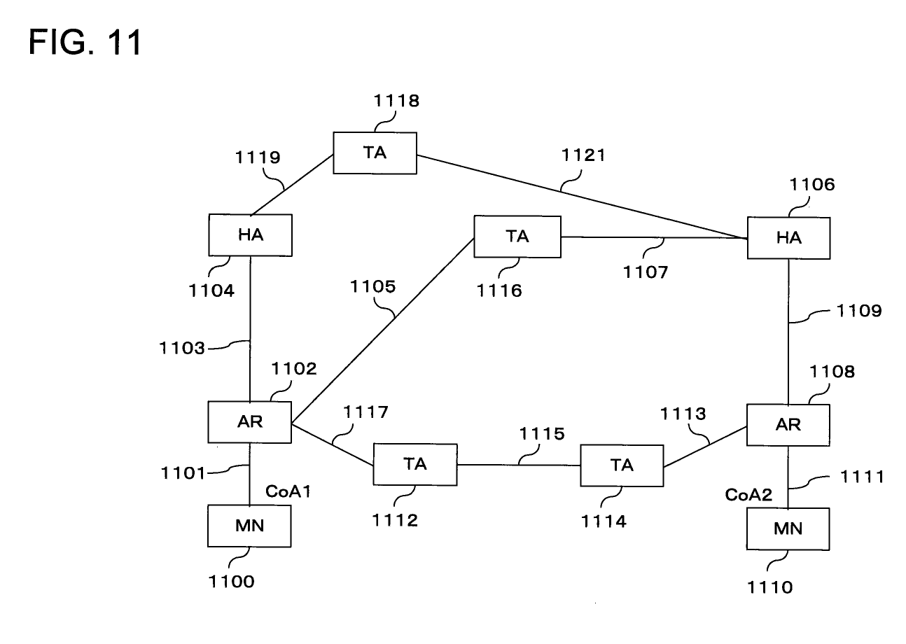

A description will be given hereinbelow of a fourth embodiment. The components of a mobile node and a relay node (TAE) in fourth to eighth embodiments are the same as those of the mobile node (MN) and the relay node (TAE) in the first embodiment, and the description of the mobile node and the relay node in the fourth embodiment and the embodiments subsequent thereto will be given with reference to FIGS. 4 and 5. FIG. 11 shows a scenario requiring the employment of a TA. As shown in FIG. 11, MN 1100 is connected through AR 1102 to a network. In a case in which the MN 1100 lies in an external network, the MN 1100 acquires a CoA1 and becomes a subordinate of the AR 1102. The AR 1102 intervenes in a connection between an HA 1104 and the MN 1100.

At the same time, MN 1110 existing at one end of a communication session is connected through AR 1108 to a network. In a case in which the MN 1110 exists outside a home domain, the MN 1110 operates under AR 1108 through the use of a CoA2. The MN 1110 is connected through AR 1108 to HA 1106.

When the discovery of a TA is implemented between a mobile node and a home agent, for example, between the MN 1100 and the HA 1106, by use of the above-described second embodiment, TA 1116 is discovered. The TA 1116 does not exist on an optimized path. The actual optimized path is a path passing through links 1101, 1117, 1115, 1113 and 1111. As shown in FIG. 1, TA 1112 and TA 1114 exist on the optimized path. For this reason, the TA 1112 or the TA 1114 is to be used for realizing the optimized communication.

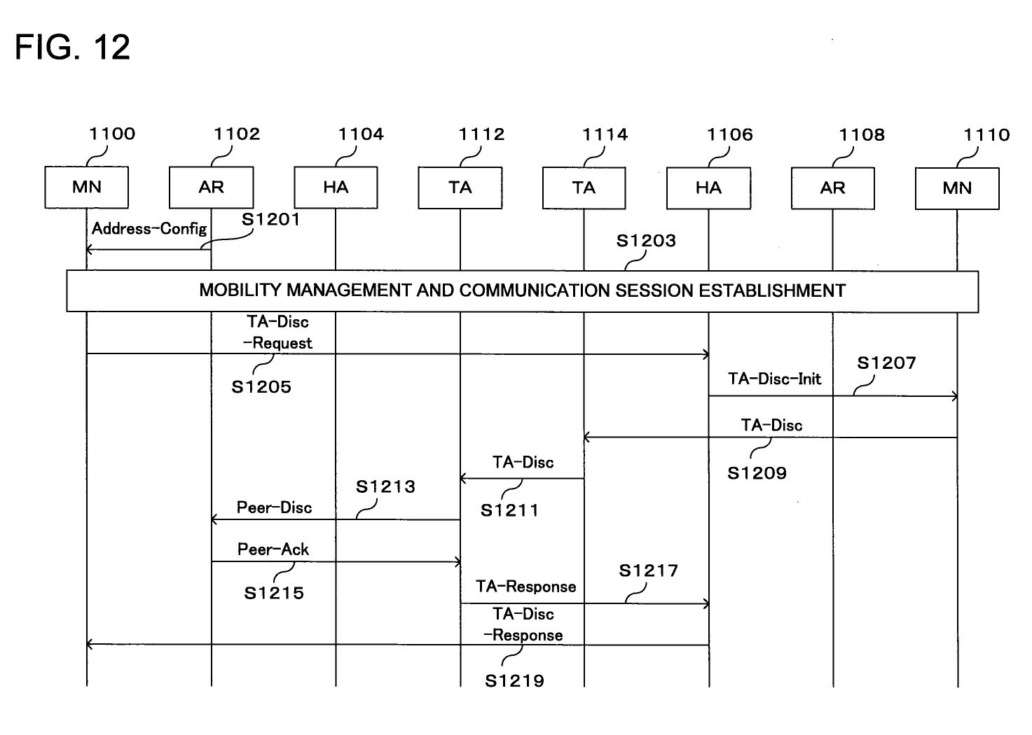

FIG. 12 shows a sequence chart for discovering the TA 1112 and the TA 1114. The direction of data traffic is from the MN 1110 to the MN 1100. As shown in FIG. 12, the MN 1100 acquires an address configuration (Address-Config) from the AR 1102 (step S1201). For example, in the case of the IPv6 stateless address auto configuration, it is a router advertise. Incidentally, the procedure for obtaining address information from a network is obvious to a person skilled in the art. Moreover, a different type of an address configuration message, such as a DHCP message, is also expressible.

After the acquisition of a fair address from a network, the MN 1100 carries out the procedure defined by the mobility management scheme. For example, in a case of MIP, it corresponds to a procedure for address registration (BU: Binding Update) in the HA 1104 when the MN 1100 exists in an external network or in other cases. By the aid of a mobility anchor (in this case, HA 1100), the MN 1100 can construct a new communication session or maintain a communication session with respect to a different node, such as the MN 1110. The above-mentioned process corresponds to the S1203 in FIG. 12. It is obvious to a person skilled in the art that a detailed operation of this process does not affect the principle of the present invention.

In a case in which the MN 1100 determines the discovery of a TA at a different communication end, for example, on an optimized path to the MN 1110, the MN 1100 (transmission means 401) transmits a TA discovery request (TA-Disc-Request) message toward the HoA at the different communication end (S1205). This TA-Disc-Request message is generated by the message generating means 400 of the MN 1100. This TA-Disc-Request message is used as a trigger for the TA discovery procedure from the different communication end. One example of a format of the TA-Disc-Request message is as follows.

TA-Disc-Request: =[Requester Address]
[Target Address]
[Policy Data]

The “Requester Address” is a destination address to be used for the TA discovery procedure or an address of a point through which a message for the discovery of a TA passes. The MN 1100 determines an address to be used on the basis of a local security policy. For example, if the MN 1100 does not require the protection of the CoA, the value of the CoA1 can be allocated to the “Requester Address”. However, in some case, it is considered that the CoA reveals the ID information, for example, the MAC address of the interface. For this reason, if the local security policy of the MN 1100 prohibits the disclosure of the CoA, the MN 1100 uses the address in the Requester Address”, e.g., the address of the AR 1102. In the case of the existence on a direct data path (direct path) between two communication nodes, for example, between the MN 1100 and the MN 1110, it is obvious to a person skilled in the art that a different address is used for the Requester Address” For example, in place of an adjacent access router, the MN 1100 can also use the address of its default gateway.

A station management function at the MN 1100 determines an address to be used on the basis of an operation situation. For example, in a case in which the MN 1100 generates a CoA through the use of the stateless address auto configuration utilizing an interface ID, a security flag is set in a station management information base (MIB). When the MN 1100 generates a TA-Disc-Request message, the MN 1100 (message generating means 400) checks the security flag in the MIB. If the flag is set (at a value configured in advance), the MN 1100 uses an address of an access router or gateway as the “Requester Address”. Otherwise, the MN 1100 can use a CoA itself of an interface as the “Requester Address”.

The “Target Address” is indicative of address information a communication end node uses at home. In the case of the MN 1110, it becomes the HoA2 which is a home address. In the case of a node which does not handle the mobile, it becomes an address used currently by this node.

The “Policy Data” contains a request from the MN 1100 for the TA selection. In a case in which TAs are discovered as a plurality of candidates on a data path, it is used for selecting a preferable TA in that session. For example, the “Policy Data” can specify the first-priority QoS metrics, such as delay, queue length, cost or the like at the selection. It is also appropriate to specify other criteria, for example, tunneling protocol, encryption method and others. It is obvious to a person skilled in the art that the criteria could also be a combination of a set of parameters.

The MN 1100 transmits a TA-Disc-Request message without any mobile IP header options like a normal IP capable node. This does not reveal the ID information with respect to the MN 1100. As shown in FIG. 12, the TA-Disc-Request message is received by the HA 1106 of the MN 1110. This is realizable using some methods.

For example, the message is transmitted toward the HoA2. In this case, the message undergoes a normal IP encapsulation with the destination address being set at the HoA2, and a special RAO (Router Alert Option) is set. This acts as a trigger whereby the HA of the MN 1110 on the path intercepts (acquires) the message and processes it. If there is no HA on the path, the message arrives at the MN 1110. In the case of supporting the RAO, the MN 1110 transfers the message to the HA. If not, the MN 1110 cancels it. A situation in which the MN 1100 (reception means 402) does not receive a response after a time set in advance elapses signifies that the MN 1110 exists at the home or the route optimization is not supported. In the other cases, the MN 1100 can continue to use the HoA2 for making the communication with the MN 1110.

An other method is that the anycast address of the domain of the MN 1110 is set as the destination address of an IP packet into which the TA-Disc-Request message is encapsulated. For example, the “HA anycast address” defined in the Non-Patent Document 4 is for making a packet delivered to a router of a subnet of the MN 1110. It is obvious to a person skilled in the art that a different type of address, such as a subnet router anycast address, is usable, as long as it reaches the HA.

In addition, it is also possible that the MN 1100 carries out a DNS Query by using a domain name known in the HA of the MN 1110, for example, “homeagent.mn2-home.domain”. The TA-Disc-Request message is transmitted toward an address determined by the DNS Query.

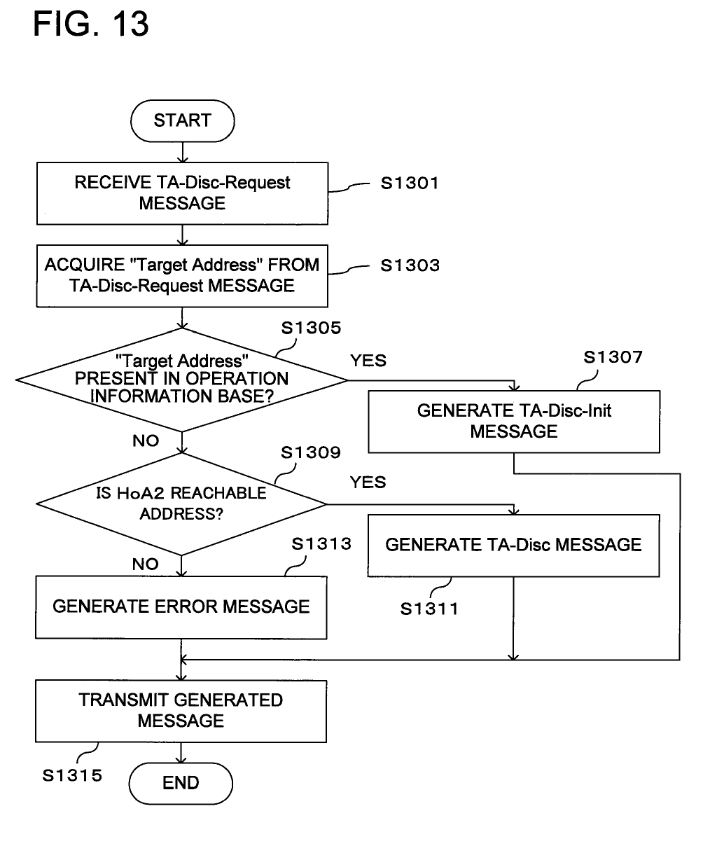

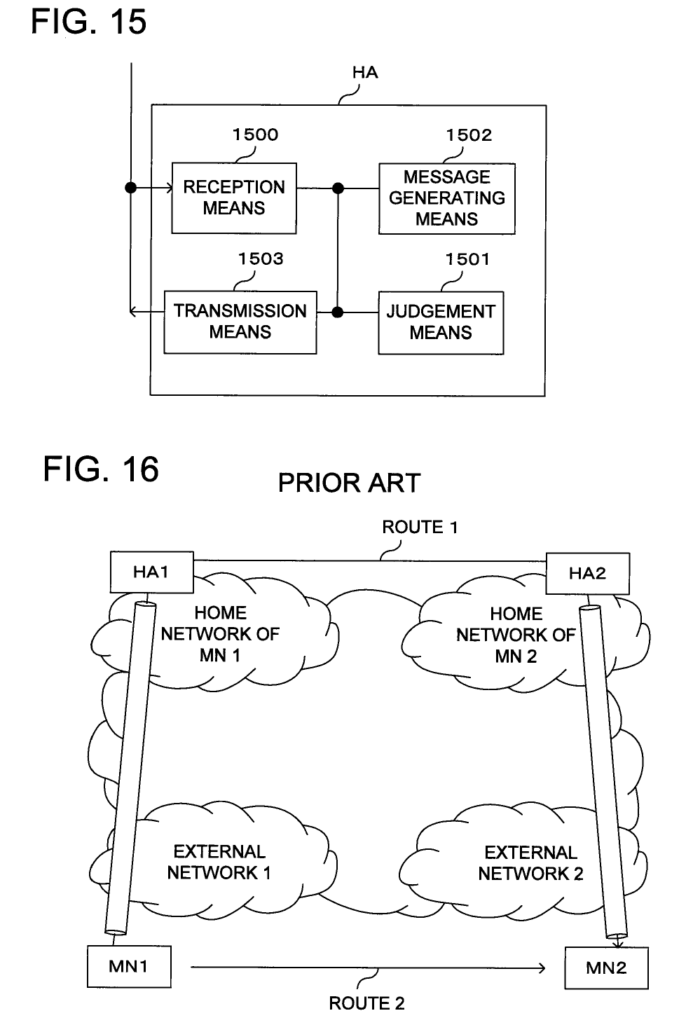

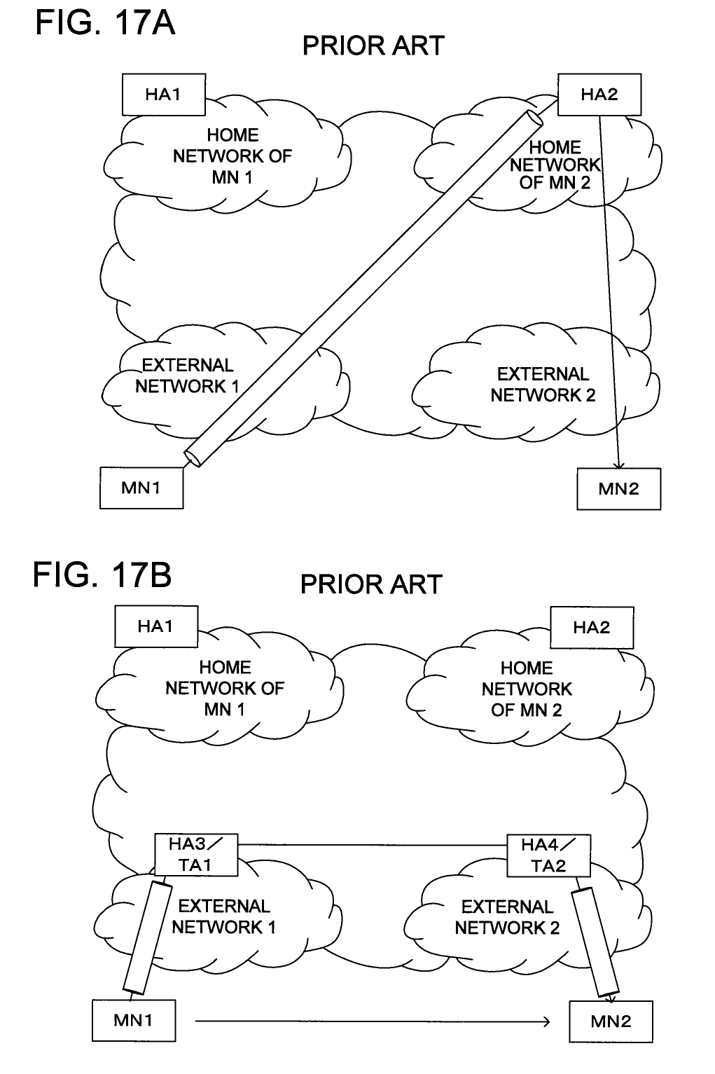

As shown in FIGS. 12 and 15, when the HA 1106 (reception means 1500) receives a TA-Disc-Request message, the HA 1106 (judgment means 1501) confirms the message type, such as the RAO value defined in advance. If the HA 1106 supports the present invention, it processes the received message. FIG. 13 is a flow chart for the message processing in the HA 1106. When the HA 1106 (reception means 1500) receives a TA-Disc-Request message (S1301), it acquires the “Target Address” from this message (S1303). The HA 1106 (judgment means 1501) checks whether or not the entry on the “Target Address” is already made in an operation information base (whether or not the “Target Address” exists in the operation information base) (S1305). For example, in the case of the use of MIP, the BU from the MN 1110 generates a BC (Binding Cache) entry in the HA 1106. The lack of the entry signifies that the mobile node exists at the home or that the BU does not arrive thereat.

In a case in which the entry regarding the “Target Address” exists in the HA 1106, the HA 1106 (message generating means 1502) generates a TA discovery initiation (TA-Disc-In it) message (S1307). The BC entry regarding the MN 1110 in the HA 1106 contains the binding between the HoA2 and the CoA2 which is the current CoA. If the entry of the information on the address of the AR 1108 can be made in the HA 1106 at the BU, the HA 1106 (message generating means 1502) can also generate a TA-Disc-In it message directed to the AR 1108. Moreover, it is also possible that the HA 1106 retrieves the address of the AR 1108 from the CoA2 of the MN 1110 by means of a server or the like to use it for generating a TA-Disc-In it message. One example of a format of the TA-Disc-In it message is as follows.

TA-Disc-In it: =[Starting Point]
[End Point]
[TA Disc Element]
[Last Node Action]
[Policy Data]

The “Starting Point” is information on a source of data traffic. In this case, it is the CoA2 which is the CoA of the MN 1110. The HA 1106 (judgment means 1501) can determine an actual value in place of this information. For example, if the HA 1106 (judgment means 1501) becomes aware that there is a node on the actual data path between the MN 1110 and the “Requester Address”, it is possible to utilize the address of this node, for example, the address of an access router of the MN 1110. It is obvious to a person skilled in the art that this does not affect the principle of the present invention.

The “End Point” contains information the HA 1106 acquires from the “Requester Address” of the TA-Disc-Request message.

The “TA Disc Element” contains information to be used in the TA discovery processing. For example, it includes the criteria for the TA selection which meets a request from the MN 1100 and which are specified in the “Policy Data” of the TA-Disc-Request message. The criteria are such as encryption method, tunneling protocol and/or QoS metrics. It is obvious to a person skilled in the art that these criteria are listed and essential requirements and options exist in each category.

The “Last Node Action” contains information for the last TA on the data path from the “Staring Point” to the “End Point”. For example, it includes the address of the HA 1106. When the last TA is discovered on the data path from the MN 1110 to the MN 1100, this TA (transmission means 503) transfers a discovery message to the HA 1106 according to the “Last Node Action”. The HA 1106 (judgment means 1501) can also designate a different node bearing that function. For example, the HA 1106 can also appoint a proxy close to the current location of the MN 1100 or appoint the HA 1104. In such a case, the HA 1106 (message generating means 1502) can replace the “Last Node Action” with the address of that node. It is obvious to a person skilled in the art that the items such as the “Last Node Action” include more complicated information defined in advance. As the information to be included therein, for example, there are information to the effect of resource reservation, information to the effect of calculation, information to the effect of the connection to a node through the use of a special protocol, and other information.

The “Policy Data” contains special control information for a TA-Disc-In it message. For example, it contains scope information so that the TA-Disc-In it message is intercepted and processed only within a specific domain or address prefix. This item also contains necessary security information so that the HA 1106 is able to match a response to the TA-Disc-In it message it sends out.

The TA-Disc-In it message is transmitted is transmitted by the transmission means 1503 toward the MN 1110 (S1207). The HA 1106 (transmission means 1503) transmits a message using the normal IP encapsulation in a state where the destination address is set at the CoA2. The RAO defined in advance can be set so that a router supporting the message type, for example, the AR 1108, intercepts and processes the message in place of the MN when needed.

As shown in FIG. 13, when, in the step S1305, the HA 1106 does not have the entry regarding the HoA2, a check is made as to whether or not the HoA2 is a reachable address (S1309). This is realizable by transmitting a Ping message to that address. In a case in which the MN 1110 is reachable at the HoA2, this signifies that the MN 1110 exists at the home. Therefore, the HA 1106 itself is a router on the data path between the “Request Address” and the MN 1110. No need exists to carry out special route optimization. However, if it is necessary that the policy conceals the information on the MN 1110 existing at the home, the HA 1106 (judgment means 1501) allocates a proper TA for the MN 1110. In this case, the HA 1106 (message generating means 1502) generates a TA-Disc message for the MN 1110 (S1311). One example of a format of the TA-Disc message is as follows.

TA-Disc: =[Starting Point]
[End Point]
[TA Disc Element]
[Last Node Action]
[Policy Data]
[TA Candidate List]

The information in the TA-Disc message is equal to one to be used in the TA-Disc-In it message. In this case, the “Starting Point” contains the address information on the HA 1106. The “End Point” contains the address information in the Requester Address” of the TA-Disc Request message. The “TA Candidate List” contains a list of TAs on a path meeting the criteria listed in the “TA Disc Element”. It is inserted by the TA on the path. The information on other items are substantially equal to those in the above-mentioned TA-Disc-In it message.

The TA-Disc message is transmitted as a special signaling application message. The TA-Disc message is encapsulated so as to flow along a data path from the “Starting Point” to the “End Point”. Moreover, a TA on the path can intercept this message. One example of a method of realizing this is that a TA-Disc message is transmitted like a NSLP layer signaling message as disclosed in the Non-Patent Document 3.

As shown in FIG. 13, when, in a step S1309, the HA 1106 (judgment means 1501) recognizes that the MN 1110 is not reachable at HoA2, it generates an error message for informing the MN 1100 of this fact (by use of the message generating means 1502) (S1313). One example of a format of the error message is as follows.

Error: =[Requester Address]
[Target Address]
[Error Code]

The “Requester Address” and the “Target Address” contain information obtained from the same-named items of the TA-Disc-Request message.

The “Error Code” contains information on the cause of error. For example, in the above-mentioned scenario, the “Error Code” indicates that it is caused by an unreachable target address. It is obvious to a person skilled in the art that more errors are defined depending on operation needs, for example, “policy inhibits route optimization”.

As shown in FIG. 13, when the HA 1106 (message generating means 1502) generates an appropriate message in the steps S1307, 1311 and 1313, the HA 1106 (transmission means 1503) sends the message to corresponding destination (S1315).

As shown in FIG. 12, the step S1205 and steps subsequent thereto handle an example of signaling when, for example, the HA 1106 has the entry on the HoA2, and as shown in FIG. 13, the HA 1106 carries out the steps S1305, 1307 and 1315.

As shown in FIG. 13, the HA 1106 (transmission means 1503) transmits a TA-Disc-In it message to the MN 1110, for example, the CoA2. When the MN 1110 (reception means, not shown) receives the TA-Disc-In it message, the MN 1110 (message generating means, not shown) processes the message and generates a TA-Disc message if the local policy permits it. The format of the TA-Disc message is as mentioned above.

In addition, when the HA 1106 recognizes that the AR 1108 supports the present invention, the HA 1106 (judgment means 1501) can determine the transmission of the TA-Disc-In it message to the AR 1108 which is an access router for the MN 1110. The AR 1108 carries out the processing for the MN 1110 in order. For example, a TA-Disc message is generated and transferred toward the MN 1100. The HA 1106 can obtain the address of the AR 1108 through the BU by the MN 1110. For example, the MN 1110 can register the AR 1108 (address thereof) together with the CoA2 in the HA 1106. The HA 1106 can obtain, from the CoA2, the address of the AR 1108 through the use of a router anycast address of a subnet of a domain of the CoA2. If the HA 1106 does not have any record regarding the address of the AR 1108, the HA 1106 (message generating means 1502) can also set a special RAO and transmit the TA-Disc-In it message toward the CoA2. In this case, the AR 1108 supporting the present invention intercepts and processes the message.

It is obvious to a person skilled in the art that the format of the TA-Disc message is essentially similar to that of the TA-Disc-In it message, and the MN 1110 or the AR 1108 can reuse the information from the TA-Disc-In it message as the TA-Disc message. The MN 1110 or the AR 1108 is required to carry out processing still needed.

As another mode, it is also possible that the HA 1106 (message generating means 1502) can generate the TA-Disc message directly and insert and encapsulate the TA-Disc message into the TA-Disc-In it message. Upon receipt of the TA-Disc-In it message, the MN 1110 (transmission means, not shown) or the AR 1108 extracts the TA-Disc message and sends it toward the MN 1100, as if the source of the TA-Disc message is the MN 1110 or the AR 1108. In this case, the TA-Disc-In it message and the TA-Disc message are identical to each other except a layer of IP layer encapsulation or additional IP header options.

In this connection, it is also acceptable that the HA 1106 (message generating means 1502) generates a TA-Disc message and transmits the TA-Disc message through the AR 1108 to the MN 1100 or the AR 1102 along a strict route. Moreover, it is also acceptable that the MN 1100 (message generating means 400) generates a TA-Disc message and transmits it as one TA-Disc message through the HA 1106 and the AR 1108 to a destination such as the MN 1100 or the AR 1102. Still moreover, it is also appropriate that the MN 1100 (message generating means 400) encapsulates a TA-Disc message into a TA-Disc-Request message or encapsulates a TA-Disc message into a TA-Disc-In it message and further encapsulates the capsulated message into a TA-Disc-Request message for generating an encapsulated message and transmits the generated encapsulated message through the HA 1106 and the AR 1108 to a destination such as the MN 1100 or the AR 1102. This enables eliminating the burden of the generation of the TA-Disc message or the TA-Disc-In it message in the HA 1106 or the AR 1108. It is also acceptable that the HA 1106 finds a node on a path between the MN 1100 and the MN 1110 by use of a DHCP or the like and transmits the generated TA-Disc message through the found node to the MN 1100 or the AR 1102. The destination of the TA-Disc message is not limited to the MN 1100 or AR 1102 mentioned above, but the destination thereof can also be the HA 1104, HA 1106 or the like.

When the MN 1110 (message generating means, not shown) generates a TA-Disc message, the MN 1110 can use an address of an AR (address of the AR 1108) as the “Starting Point”. As a result, a path through which the TA-Disc message transmitted with the address of the AR 1108 being set as the “Starting Point” passes is the same as a path through which a TA-Disc transmitted with the MN 1110 being set as the “Starting Point” passes. When the MN 1110 TA-Disc-transmits the address of the AR 1108 as the “Starting Point”, the MN 1110 can conceal its own CoA.

The TA-Disc message is transmitted by a node made to generate a message, such as the MN 1110, toward the “End Point” or by way of the “End Point”. That is, it is also acceptable that the destination of the TA-Disc message is the “End Point” as mentioned above and that it is a different node (HA 1104, HA 1106 or the like) as mentioned above. When the different node becomes the destination, the TA-Disc message is set by use of a strict route so as to pass through the “End Point”. It is also acceptable that, as mentioned above, the TA-Disc message is stopped by a TA on the route without reaching the “End Point” or a destination (by the above-mentioned Last Node Action). In a case in which an NSIS type signaling protocol is used for carrying the TA-Disc message, the TA-Disc message is transmitted as a D-mode message which does not require the MN 1110 which knows peer information in advance. For example, the TA-Disc message is encapsulated into a UDP (User Datagram Protocol) packet having RAO previously defined in the IP header.

A signaling aware node (for example, TA 1114) supporting a TA discovery application, for example, processing the RAO value, intercepts the TA-Disc message as shown in FIG. 12 (S1209).

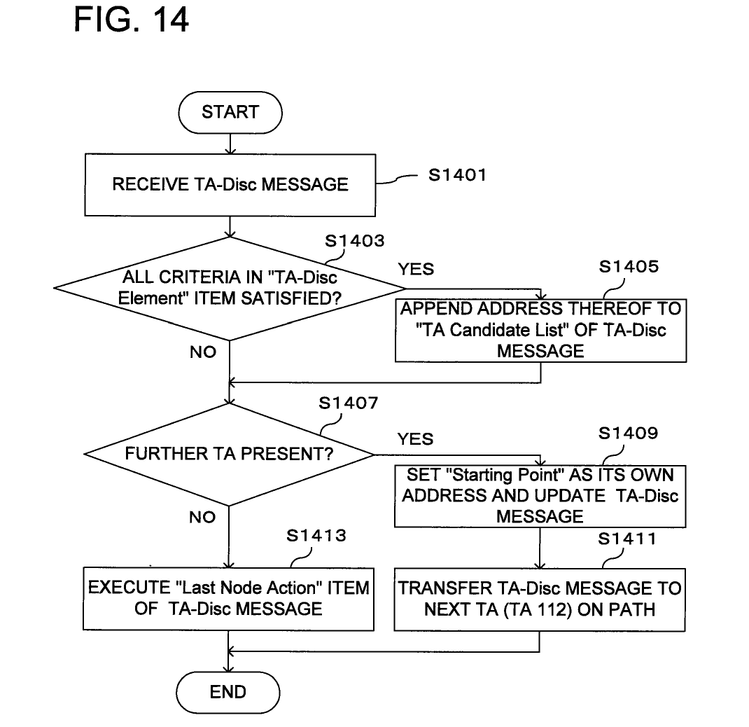

When the TA 1114 (reception means 500) receives the TA-Disc message, it conducts the processing according to a logic set in advance. FIG. 14 is a flow chart showing a TA-Disc message processing flow.

Upon receipt of a TA-Disc message (S1401), a node (judgment means 501) checks whether or not it satisfied all the criteria in the “TA Disc Element”, for example, it is capable of supporting tunnel options listed and supporting encapsulation methods (S1403). If all the criteria reach satisfaction, the TA 1114 (message generating means 502) appends its own address to the “TA Candidate List” in the TA-Disc message (S1405), and the operation advances to a step S1407. It is obvious to a person skilled in the art that many information such as characters of the TA, the QoS supported, the tunnel method supported and the encapsulation used are embedded in the list. If the TA 1114 is not capable of satisfying the mandatory criteria, the operation proceeds directly to The step S1407.

As shown in FIG. 14, a TA, such as the TA 1114 (judgment means 501), checks whether or not a further TA exists on the path from itself toward the “End Point” indicated in the TA-Disc message (S1407). The TA 1114 grasps the presence of the TA on the basis of the existing signaling associations, such as the NTLP layer message association in the case of NSIS. If the current TA, for example, the TA 1112, does not have any signaling association for the particular address peer, on the basis of a peer discovery message (Peer-Disc message), it checks whether or not an adjacent TA exists in the downstream direction of the path and, if existing, establishes the relationship with that TA.

In this case, as shown in FIG. 12, the description will be given on the assumption that the TA 1112 does not have the existing signaling association information. The TA 1112 transmits a Peer-Disc message toward the “End Point”, for example, the AR 1102 (S1213). In a case in which the AR 1102 supports the TA discovery signaling application, it makes a response with a peer acknowledgment message (Peer-Ack message) (S1215). In a case in which the AR 1102 supports the signaling protocol but not supporting the TA discovery signaling application, it makes a response with a negative Peer-Ack message. If the AR 1102 does not support such a signaling protocol at all, an IP layer feedback, such as an ICMP error message, is transmitted to the TA 1112.

The TA 1112 makes a comparison between the address of a response node to the Peer-Ack message, such as the address of the AR 1102, and the address of the “End Point”. If they are the same as each other, this signifies that the current TA is the last TA on this path.

In the step S1407 in FIG. 14, if a TA, such as the TA 1114, recognizes that there is another TA on the path, it sets its own address as the “Staring Point”, thereby updating the TA-Disc message (through the use of the message generating means 502) (S1409). The updated TA-Disc message is transferred to the next TA on the path, for example, the TA 1112 as shown in FIG. 12 (S1422).

In the step S1407 in FIG. 14, if the TA, such as the TA 1112, does not discover a TA on the path, it carries out the “Last Node Action” item in the TA-Disc message (S1413). For example, it transfers the updated TA-Disc message to the address indicated in the “Last Node Action” item. For example, the updated TA-Disc message is transferred as a TA-Response message toward the HA 1106 as shown in FIG. 12 (S1217). It is obvious to a person skilled in the art that the TA-Response message with only a different transfer mechanism can share the same format as that of the TA-Disc message.

When the HA 1106 (reception means 1500) receives the TA-Response message (S1217), the HA 1106 (judgment means 1501) checks the “TA Candidate List”. If this list is not empty, it selects one of the TAs as a candidate on the basis of the local policy or the priority criteria indicated by the MN 1100. Moreover, the HA 1106 can also consider the priority criteria indicated by the HA 1110. The other methods are also employable for the selection of a TA from the candidates, and it is obvious that the employment thereof does not affect the principle of the present invention.

Upon the selection of a TA, the HA 1106 can make a response to the MN 1100 with a TA discovery response message (TA-Disc-Response message) (S1219). One example of a format of the TA-Disc-Response message is as follows.

TA-Disc-Response: =[Requester Address]
[Target Address]
[TA Candidate]
[Policy Data]

The “Requester Address” and the “Target Address” agree with (match) those in the corresponding TA-Disc-Request message. This eliminates the need for a mobile node, such as the MN 1100, to hold the information on this request. The “TA Candidate” is a TA selected by the HA 1106 on the basis of the policy. It is obvious to a person skilled in the art that the “TA Candidate” is expanded (developed) in the list so that a mobile node, such as the MN 1100 itself, can select the best TA.

It is obvious to a person skilled in the art that, for accurate generation of a TA-Disc-Response message, when the HA 1106 (reception means 1500) receives a TA-Disc-Request, a need to generate processing data. For example, there is a need for the HA 1106 to store the “Requester Address”, the “Target Address”, and the source address of the TA-Disc-Request message if it is different from the “Requester Address”. These information are stored, with a timer attached, in a state associated with the processing ID. In a case in which the HA 1106 does not receive a TA-Response message before the timer reaches termination, the HA 1106 (transmission means 1503) transmits a TA-Disc-Response message having an empty “TA Candidate” for indicating a failure of the TA discovery (S1219). In order for the HA 1106 to establish an association between a TA-Disc-In it message to be transmitted and a TA-Response message, the processing ID is appended to the “Policy Data” items of all the messages.

When a mobile node, such as the MN 1100 (reception means 402), receives a TA-Disc-Response message having a non-empty “TA Candidate”, it selects an appropriate TA and initiates the route optimization processing. For example, in a case in which the MN 1100 desires to carry out the route optimization relative to the MN 1110 by the HoA2, it can try to make a contact with a TA through the home agent, such as the HA 1104. The HA 1104 verifies the TA and, if the verification is successful, transfers a request to the TA with the CoA1. The TA makes a verification thereon with respect to the HA of the MN 1110, such as the HA 1106, and obtains the CoA2 in order to establish bi-directional tunnel toward both the CoA1 and the CoA2. This enables an optimized bi-directional tunnel to be established without revealing any location to any unauthorized party.

### Fifth Embodiment

In the processing according to the fourth embodiment, the HA 1106 can receive a TA-Disc-Request message having the “Requester Address” pertaining to the same domain as that of the MN 1110. For example, the “Requester Address” shares the same prefix as the CoA2. This means that the MN 1100 and the MN 1110 are in the same domain or in the same subnet. Thus, the normal TA discovery is not capable of yielding an optimized TA or of find a TA.

In this case, since the two mobile nodes lie in the same domain, the optimized TA becomes a TA closest to the domain. Accordingly, the HA 1106 (transmission means 1503) can transmit the TA-Disc message directly toward the domain. For this reason, the TA discovery procedure to be used is the same as that in a case in which the MN 1110 exists at the home in the fourth embodiment.

Alternatively, the HA 1106 can carry out the QUERY processing by using a domain controller which determines the best TA in a database or in a session. In this case, when a TA is found without actually transmitting a TA-Disc message, the HA 1106 can transmit TA-Disc Response message directly. Moreover, it is also acceptable that the HA 1106 itself becomes a TA.

### Sixth Embodiment

The above description of the fourth and fifth embodiment has been given of a case in which data traffic is transmitted from the MN 1110 to the MN 1100. The actual TA discovery processing starts at the data transmission source side. That is, a TA-Disc-In it message or TA-Disc message is transmitted from a home agent or a router in the home domain of the data transmission source. For this reason, in a case in which the data traffic direction is from the MN 1100 to the MN 1110, the improvement of the present invention becomes necessary.

In such a case, when the data transmission source, such as the MN 1100 desire the route optimization, it can transmit an optimization trigger toward the MN 1110 through the home agents, such as the HA 1104 and the HA 1106. For example, this message can be a home test initiation (HoTI: home Test In it) message defined in the Non-Patent Document 4 having an additional “Privacy” flag. Upon receipt of an HoTI having a “privacy” flag, the MN 1110 does not carry out the normal home test (HoT). Instead, the MN 1110 generates and transmits a TA-Disc-Request message toward the HoA1 which is the home address of the MN 1100. It is obvious to a person skilled in the art that the rest of the operation is similar to that in the fourth and fifth embodiments and, the MN 1100, the MN 1110 and the their corresponding home agents and access routers are also the same. For example, the HA 1104 realizes the functions described as the HA 1106 in the fourth and fifth embodiments.

### Seventh Embodiment

According to the present invention, the data transmission source, such as the MN 1110, can utilize a TA-Disc message which contains the information on the data receiver, such as the MN 1100. In a case in which there is only one session in the data transmission source, it is possible to presume the relationship between the data receiver, such as the home address of the MN 1100, and the address of the “End Point”. Although the “End Point” does not reveal the actual location of the MN 1100, the MN 1110 is capable of presuming the location. For the purpose of preventing such a presumption, the data receiver can initiate the simultaneous transmission of some TA-Disc-Request messages from different addresses. For example, in addition to the direct transmission of the TA-Disc-Request message to the HA 1106, the MN 1100 can make a request for the transmission of the TA-Disc-Request message to a home agent, such as the HA 1104, at the same time. Owing to this method, the MN 1110 cannot presume the actual location of the MN 1100.

### Eighth Embodiment

In a case in which a mobile node, such as the MN 1100, receives a TA-Disc-Response message having an empty “TA Candidate”, it signifies that there is no TA, which meets the requirement, on an optimized path. For this result, the MN 1100 continues the communication through the home agent because TAs, which does not lie on the optimized path, do not provide a better effect to the user.

In a case in which the MN 1100 desires to use the TA for some reason, for example, by reason that the current path cannot maintain the communication session, the MN 1100 can return to the normal TA discovery method, for example, a method based on a home agent.

The respective functional blocks used in the above description of the respective embodiments of the present invention are typically realized with an LSI (Large Scale Integration) which is an integrated circuit. It is also acceptable that these blocks are individually formed as one chip, or that a portion of or all of these blocks are formed as one chip. Although an LSI is taken in this case, it is sometimes referred to as an IC (Integrated Circuit), system LSI, super LSI or ultra LSI according to the level of integration. Moreover, the technique for the formation of an integrated circuit is not limited to the LSI, but it is also realizable with a dedicated circuit or a general-purpose processor. After the manufacturing of an LSI, it is also acceptable to utilize an FPGA (Field Programmable Gate Array) which enables the programming or a reconfigurable processor which allows the reconfiguration of connections and setting of circuit cells in the interior of the LSI. Still moreover, if a technique for the formation of an integrated circuit replaceable with the LSI appears owing to advance in semiconductor technology or a different technology derived therefrom, the functional blocks can naturally be integrated through the use of this technique. For example, a biotechnology or the like may be applicable.

### INDUSTRIAL APPLICABILITY

A node discovery method according to the present invention, and a mobile node, relay node and home agent, which are used for this method, can detect a TA allowing a quasi-optimized data route for the achievement of a quasi-optimized data route while guarding a location privacy of MN in the mobile IPv6, so they are useful for anode discovery method of discovering a node providing a route approximate to an optimized route while guarding a location privacy and a mobile node, relay node, home agent and others, which are for use in this method.

1. A node discovery method of, in a data communication system in which a mobile node which is connected to a first network and a communication node which is a communication partner of said mobile node and which is connected to a second network make communication with each other through a plurality of relay nodes located within an internetwork including said first network, said second network, a first home network which is a home network of said mobile node containing a home agent of said mobile node and a second home network which is a home network of said communication node containing a home agent of said communication node, discovering a processing node which is, of said plurality of relay nodes, a relay node capable of processing a message with a predetermined format and positioned on a route through which a data packet to be transmitted from said mobile node to said communication node passes and adjacent to said communication node, comprising:
a step in which said mobile node transmits a first message, which is the message with the predetermined format, for the discovery of said processing node to said communication node;
a step in which said relay node capable of processing the message with the predetermined format makes a judgment on the basis of the first message, received, as to whether said relay node is said processing node; and
a step in which, when the judgment shows that said relay node itself is said processing node, said relay node which has made the judgment and which is capable of processing the message with the predetermined format transmits a second message, indicating that it becomes said processing node, to said mobile node.

2. The node discovery method according to claim 1, wherein said first message includes information for prompting said relay node capable of processing the message with the predetermined format to acquire the first message.

3. The node discovery method according to claim 1, wherein said mobile node transmits the first message through said home agent of said mobile node.

4. The node discovery method according to claim 1, wherein when said relay node capable of processing the message with the predetermined format receives the first message, said relay node converts an address of a source of the first message into its own address.

5. The node discovery method according to claim 1, wherein when said relay node capable of processing the message with the predetermined format receives the first message and makes a judgment as to whether or not it is said processing node, said relay node makes the judgment on the basis of information on an adjacent relay node capable of processing the message with the predetermined format, stored in its predetermined storage area, and information on a destination of the first message.

6. A mobile node in a data communication system in which a mobile node which is connected to a first network and a communication node which is a communication partner of said mobile node and which is connected to a second network make communication with each other through a plurality of relay nodes located within an internetwork including said first network, said second network, a first home network which is a home network of said mobile node containing a home agent of said mobile node and a second home network which is a home network of said communication node containing a home agent of said communication node, the mobile node being used for a node discovery method of discovering a processing node which is, of said plurality of relay nodes, a relay node capable of processing a message with a predetermined format and positioned on a route through which a data packet to be transmitted from said mobile node to said communication node passes and adjacent to said communication node, comprising:
message generating means for generating a first message which is the message with the predetermined format for discovering said processing node;
transmission means for transmitting the generated first message to said communication node; and
reception means for receiving, from said relay node capable of processing the message with the predetermined format, judged as said processing node, a second message indicating that it becomes said processing node.

7. The mobile node according to claim 6, wherein said message generating means puts, in the first message, information for prompting said relay node capable of processing the message with the predetermined format to acquire the first message.

8. The mobile node according to claim 6, wherein said transmission means transmits the first message through said home agent of said mobile node.

9. A relay node in a data communication system in which a mobile node which is connected to a first network and a communication node which is a communication partner of said mobile node and which is connected to a second network make communication with each other through a plurality of relay nodes located within an internetwork including the first network, the second network, a first home network which is a home network of said mobile node containing a home agent of said mobile node and a second home network which is a home network of said communication node containing a home agent of said communication node, the relay node being used for a node discovery method of discovering a processing node which is, of said plurality of relay nodes, a relay node capable of processing a message with a predetermined format and positioned on a route through which a data packet to be transmitted from said mobile node to said communication node passes and adjacent to said communication node, comprising:
reception means for receiving a first message serving as the message with the predetermined format for discovering said processing node, transmitted from said mobile node;
judgment means for making a judgment on the basis of the received first message as to whether or not said relay node is said processing node;
message generating means for, when the judgment shows that it is said processing node, generating a second message indicative of the fact that it becomes said processing node; and
transmission means for transmitting the generated second message to said mobile node.

10. The relay node according to claim 9, wherein the first message includes information for prompting said relay node capable of processing the message with the predetermined format to acquire the first message.

11. The relay node according to claim 9, wherein said judgment means converts an address of source of the received first message into its own address.

12. The relay node according to claim 9, wherein, when said judgment means makes a judgment as to whether or not said relay node is said processing node, it makes the judgment on the basis of information on an adjacent relay node capable of processing the message with the predetermined format, stored in its own predetermined storage area, and information on a destination of the first message.

13. A node discovery method of, in a data communication system in which a mobile node which is connected to a first network and a communication node which is a communication partner of said mobile node and which is connected to a second network make communication with each other through a plurality of relay nodes located within an internetwork including the first network, the second network, a first home network which is a home network of said mobile node containing a home agent of said mobile node and a second home network which is a home network of said communication node containing a home agent of said communication node, discovering a processing node which is, of said plurality of relay nodes, a relay node capable of processing a message with a predetermined format and positioned on a route through which a data packet to be transmitted from said mobile node to said communication node passes, comprising:
a step in which said mobile node transmits, to a predetermined transmission destination, a first message, which is the message with the predetermined format for discovering said processing node and which includes predetermined hop information for setting, as said processing node, a relay node positioned at a predetermined hop destination on the route from said mobile node and capable of processing the message with the predetermined format;
a step in which said relay node capable of processing the message with the predetermined format makes a judgment on the basis of the received first message as to whether or not it is said processing node; and
a step in which, when the judgment shows that it is said processing node, said relay node capable of processing the message with the predetermined format, making the judgment transmits, to said mobile node, a second message indicating that it becomes said processing node.

14. The node discovery method according to claim 13, wherein the first message includes information for prompting said relay node capable of processing the message with the predetermined format to acquire the first message.

15. The node discovery method according to claim 13, wherein, when said relay node capable of processing the message with the predetermined format receives the first message and makes a judgment that it is not said processing node, said relay node transfers the first message in a state where the hop number indicative of the number of times of hop of the first message is incremented by 1.

16. The node discovery method according to claim 15, wherein when said relay node capable of processing the message with the predetermined format receives the first message, said relay node makes a judgment on the basis of the hop number indicative of the number of times of hop of the first message and the predetermined hop information included in the first message as to whether or not it is said processing node.

17. A mobile node in a data communication system in which a mobile node which is connected to a first network and a communication node which is a communication partner of said mobile node and which is connected to a second network make communication with each other through a plurality of relay nodes located within an internetwork including the first network, the second network, a first home network which is a home network of said mobile node containing a home agent of said mobile node and a second home network which is a home network of said communication node containing a home agent of said communication node, said mobile node being used for a node discovery method of discovering a processing node which is, of said plurality of relay nodes, a relay node capable of processing a message with a predetermined format and positioned on a route through which a data packet to be transmitted from said mobile node to said communication node passes, comprising:
message generating means for generating a first message, which is the message with the predetermined format for discovering said processing node and which includes predetermined hop information for setting, as said processing node, a relay node positioned at a predetermined hop destination on the route from said mobile node and capable of processing the message with the predetermined format;
transmission means for transmitting the generated first message to a predetermined transmission destination; and
reception means for receiving, from said relay node capable of processing the message with the predetermined format, making the judgment that it is said processing node, a second message indicating that it becomes said processing node.

18. The mobile node according to claim 17, wherein said message generating means puts, in the first message, information for prompting said relay node capable of processing the message with the predetermined format to acquire the first message.

19. A relay node in a data communication system in which a mobile node which is connected to a first network and a communication node which is a communication partner of said mobile node and which is connected to a second network make communication with each other through a plurality of relay nodes located within an internetwork including the first network, the second network, a first home network which is a home network of said mobile node containing a home agent of the mobile node and a second home network which is a home network of said communication node containing a home agent of said communication node, said relay node capable of processing a message with a predetermined format being used for a node discovery method of discovering a processing node which is, of said plurality of relay nodes, a relay node capable of processing the message with the predetermined format and positioned on a route through which a data packet to be transmitted from said mobile node to said communication node passes, comprising:
reception means for receiving a first message which the message with the predetermined format transmitted from the mobile node for discovering the processing node and which includes predetermined hop information for setting, as the processing node, a relay node positioned at a predetermined hop destination on the route from the mobile node and capable of processing the message with the predetermined format;
judgment means for making a judgment on the basis of the received first message as to whether or not said relay node itself is said processing node;
message generating means for, when the judgment shows that said relay node itself is the processing node, generating a second message indicative of the fact that said relay node itself becomes the processing node; and
transmission means for transmitting the generated second message to said mobile node.

20. The relay node according to claim 19, wherein the first message includes information for prompting said relay node capable of processing the message with the predetermined format to acquire the first message.

21. The relay node according to claim. 19, wherein, when said judgment means makes a judgment that said relay node itself is not said processing node, the hop number indicative of the number of times of hop of the first message is incremented by 1.

22. The relay node according to claim 21, wherein said judgment means makes a judgment on the basis of the hop number indicative of the number of times of hop of the first message and the predetermined hop information included in the first message as to whether or not the relay node itself is said processing node.

23. The node discovery method according to claim 1, wherein, in a case in which said mobile node moves from the first network to establish a connection with a different network included in the internetwork,
when a first route for the passage of the message with the predetermined format transmitted for discovering a processing node before the movement which is said processing node when said mobile node has been in connection with the first network before the movement intersects with a second route for the passage of the message with the predetermined format transmitted for discovering said processing node in the different network which is a new connection and the relay node capable of processing the message with the predetermined format immediately after convergence of the first route and the second route is positioned on the mobile node side with respect to the processing node before the movement on the route at the convergence, the processing node before the movement is continuously used as said processing node.

24. The mobile node according to claim 6, wherein, in a case in which said mobile node itself moves from the first network to establish a connection with a different network included in the internetwork,
said reception means receives a message, indicating that a processing node before the movement which is the processing node discovered at the connection with the first network before the movement is to be continuously used as said processing node, from said relay node which is capable of processing the message with the predetermined format and which has received the message with the predetermined format transmitted from said transmission means for discovering said processing node in the different network which is a new connection and, said relay node is capable of processing the message with the predetermined format immediately after the convergence of the first route and the second route when a first route for the passage of the message with the predetermined format transmitted for discovering the processing node before the movement which is said processing node at the connection with the first network before the movement intersects with a second route for the passage of the message with the predetermined format transmitted for discovering the processing node in the different network which is the new connection,
said judgment means determines, on the basis of the message received by said reception means, that the processing node before the movement is used as said processing node.

25. The relay node according to claim 9, wherein, in a case in which said mobile node moves from the first network to establish a connection with a different network included in the internetwork,
when a first route for the passage of the message with the predetermined format transmitted for discovering a processing node before the movement which is said processing node when said mobile node has been in connection with the first network before the movement intersects with a second route for the passage of the message with the predetermined format transmitted for discovering the processing node in the different network which is a new connection, said judgment means of said relay node capable of processing the message with the predetermined format immediately after convergence of the first route and the second route makes a judgment as to whether or not said relay node is positioned on the mobile node side with respect to the processing node before the movement on the route at the convergence and,
when the judgment in said judgment means shows that it is positioned on the mobile node side with respect to the processing node before the movement on the route at the convergence, said message generating means generates a message indicating that the processing node before the movement is to be continuously used as said processing node, and
said transmission means transmits the generated message to said mobile node.

26. A node discovery method of, in a data communication system in which a mobile node which is connected to a first network and a communication node which is a communication partner of said mobile node and which is connected to a second network make communication with each other through a plurality of relay nodes located within an internetwork including the first network, the second network, a first home network which is a home network of said mobile node containing a home agent of said mobile node and a second home network which is a home network of said communication node containing a home agent of said communication node, discovering a processing node which is, of said plurality of relay nodes, a relay node positioned on a direct path between said mobile node and said communication node, comprising:
a step in which said mobile node or a predetermined node in the first network, with which said mobile node is in connection, transmits a first message to said home agent of said communication node for making a request for discovering said processing node;
a step in which, on the basis of received the first message, said home agent of said communication node transmits a second message for giving an instruction for initiating the discovery of said processing node to said communication node or a predetermined node in the second network with which said communication node is in connection;
a step in which said communication node or said predetermined node in the second network with which said communication node is in connection transmits a third message for the discovery of said processing node on the basis of information included in the second message;
a step in which said relay node which has received the third message makes a judgment on the basis of the third message as to whether or not said relay node itself is capable of becoming said processing node and, if capable, transmits information on said relay node to said home agent of said communication node; and
a step in which said home agent of said communication node transmits the received information on said relay node capable of becoming said processing node to said mobile node or said predetermined node in the first network with which said mobile node is in connection.

27. The node discovery method according to claim 26, wherein said mobile node or said predetermined node in the first network with which said mobile node is in connection transmits the first message through said home agent of said mobile node to said home agent of said communication node.

28. The node discovery method according to claim 26, wherein, in a case in which said relay node which has received the third message makes a judgment that said relay node itself is capable of becoming said processing node, when said relay node makes a judgment that a different node capable of becoming said processing node exists between said relay node itself and a node which is a destination of the third message, said relay node transfers the third message in a state where information on said relay node itself is appended thereto.

29. The node discovery method according to claim 26, wherein, at the transmission of the second message, said home agent of said communication node transmits the second message, placed into an encapsulated state where the generated third message is inserted into the second message, to said communication node or said predetermined node in the second network with which said communication node is in connection and, at the transmission of the third message, said communication node or said predetermined node in the second network with which said communication node is in connection extracts the third message from the received encapsulated second message and transmits the third message on the basis of information included in the second message.

30. A node discovery method of, in a data communication system in which a mobile node which is connected to a first network and a communication node which is a communication partner of said mobile node and which is connected to a second network make communication with each other through a plurality of relay nodes located within an internetwork including the first network, the second network, a first home network which is a home network of said mobile node containing a home agent of said mobile node and a second home network which is a home network of said communication node containing a home agent of said communication node, discovering a processing node which is, of said plurality of relay nodes, a relay node positioned on a direct path between said mobile node and said communication node, comprising:
a step in which said mobile node or a predetermined node in the first network, with which said mobile node is in connection, transmits a message for the discovery of said processing node to said home agent of said communication node;
a step in which said home agent of said communication node transfers the received message toward said communication node or a predetermined node in the second network with which said communication node is in connection;
a step in which said communication node or said predetermined node in the second network with which said communication node is in connection transmits the received message on the basis of information included in the message;
a step in which said relay node which has received the message makes a judgment on the basis of the message as to whether or not said relay node itself is capable of becoming said processing node and, if capable, transmits information on said relay node itself to said home agent of said communication node; and
a step in which said home agent of said communication node transmits the received information on said relay node capable of becoming the processing node to said mobile node or said predetermined node in the first network with which said mobile node is in connection.

31. The node discovery method according to claim 26, wherein, when said home agent of said communication node makes a judgment, on the basis of the received first message or said message, that the first network is the same as the second network, said home agent of said communication node determines that said home agent itself becomes said processing node, or said home agent specifies a predetermined node as said processing node.

32. A node discovery method of, in a data communication system in which a mobile node which is connected to a first network and a communication node which is a communication partner of said mobile node and which is connected to a second network make communication with each other through a plurality of relay nodes located within an internetwork including the first network, the second network, a first home network which is a home network of said mobile node containing a home agent of said mobile node and a second home network which is a home network of said communication node containing a home agent of said communication node, discovering a processing node which is, of said plurality of relay nodes, a relay node positioned on a direct path between said mobile node and said communication node, comprising:
a step in which, when a direction of data traffic is from said mobile node to said communication node, said communication node or a predetermined node in the second network with which said communication node is in connection generates the first message on the basis of a fourth message indicative of a request for the initiation of the discovery of said processing node, received from said mobile node or a predetermined node in the first network with which said mobile node is in connection, and transmits the first message to said home agent of said mobile node;
a step in which said home agent of said mobile node transmits a second message, indicating the initiation of the discovery of said processing node on the basis of the received first message, toward said mobile node or said predetermined node in the first network with which said mobile node is in connection;
a step in which said mobile node or said predetermined node in the first network with which said mobile node is in connection transmits a third message for the discovery of said processing node on the basis of information included in the second message;
a step in which said relay node which has received the third message makes a judgment on the basis of the third message as to whether or not said relay node itself is capable of becoming said processing node and, if capable, transmits information on said relay node itself to said home agent of said mobile node; and
a step in which said home agent of said mobile node transmits the received information on the relay node itself capable of becoming the processing node to said communication node or said predetermined node in the second network with which said communication node is in connection.

33. The node discovery method according to claim 26, wherein said mobile node or said predetermined node in the first network with which said mobile node is in connection transmits the plurality of first messages to a plurality of addresses.

34. The node discovery method according to claim 26, wherein, if said mobile node or said predetermined node in the first network with which said mobile node is in connection does not receive the information on said relay node capable of becoming said processing node from said home agent of said communication node, said mobile node or said predetermined node makes a communication through said home agent of said mobile node.

35. A mobile node in a data communication system in which a mobile node which is connected to a first network and a communication node which is a communication partner of the mobile node and which is connected to a second network make communication with each other through a plurality of relay nodes located within an internetwork including the first network, the second network, a first home network which is a home network of said mobile node containing a home agent of the mobile node and a second home network which is a home network of said communication node containing a home agent of said communication node, the mobile node being used for a node discovery method of discovering a processing node which is, of said plurality of relay nodes, a relay node positioned on a direct path between said mobile node and said communication node, comprising:
message generating means for generating a first message for making a request for the discovery of said processing node; and
transmission means for transmitting the generated first message to said home agent of said communication node.

36. The mobile node according to claim 35, wherein said transmission means transmits the first message through said home agent of said mobile node to said home agent of said communication node.

37. A mobile node in a data communication system in which a mobile node which is connected to a first network and a communication node which is a communication partner of said mobile node and which is connected to a second network make communication with each other through a plurality of relay nodes located within an internetwork including the first network, the second network, a first home network which is a home network of said mobile node containing a home agent of said mobile node and a second home network which is a home network of said communication node containing a home agent of said communication node, the mobile node being used for a node discovery method of discovering a processing node which is, of said plurality of relay nodes, a relay node positioned on a direct path between said mobile node and said communication node, comprising:
message generating means for generating a message for the discovery of said processing node; and
transmission means for transmitting the generated message to said home agent of said communication node.

38. A mobile node in a data communication system in which a mobile node which is connected to a first network and a communication node which is a communication partner of said mobile node and which is connected to a second network make communication with each other through a plurality of relay nodes located within an internetwork including the first network, the second network, a first home network which is a home network of said mobile node containing a home agent of said mobile node and a second home network which is a home network of said communication node containing a home agent of said communication node, the mobile node being used for a node discovery method of discovering a processing node which is, of said plurality of relay nodes, a relay node positioned on a direct path between said mobile node and said communication node, comprising:
message generating means for, when a direction of data traffic is from said mobile node to said communication node, generating a message for making a request for the initiation of the discovery of said processing node; and
transmission means for transmitting the generated message to said communication node or a predetermined node in the second network with which said communication node is in connection.

39. The mobile node according to claim 36, wherein said message generating means generates the plurality of first messages, and said transmission means transmits the plurality of generated first messages to a plurality of addresses.

40. The mobile node according to claim 35, wherein, in the case of no reception of the information on said relay node capable of becoming said processing node from said home agent of said communication node, said transmission means makes a communication through said home agent of said mobile node.

41. A home agent of a communication node in a data communication system in which a mobile node which is connected to a first network and a communication node which is a communication partner of said mobile node and which is connected to a second network make communication with each other through a plurality of relay nodes located within an internetwork including the first network, the second network, a first home network which is a home network of said mobile node containing a home agent of the said node and a second home network which is a home network of said communication node containing a home agent of said communication node, the home agent of said communication node being used for a node discovery method of discovering a processing node which is, of said plurality of relay nodes, a relay node positioned on a direct path between said mobile node and said communication node, comprising:
reception means for receiving a first message for making a request for the discovery of said processing node, transmitted from said mobile node or a predetermined node in the first network with which said mobile node is in connection;
message generating means for generating a second message indicating the initiation of the discovery of said processing node on the basis of the received first message; and
transmission means for transmitting the generated second message toward said communication node or a predetermined node in the second network with which said communication node is in connection,
wherein said transmission means transmits the information on the relay node capable of becoming said processing node, received through said reception means, to said mobile node or said predetermined node in the first network with which said mobile node is in connection.

42. The home agent according to claim 41, wherein, at the transmission of the second message, said transmission means transmits the second message placed into an encapsulated state where a third message for the discovery of said processing node, generated by said message generating means, is inserted into the second message toward said communication node or said predetermined node in the second network with which said communication node is in communication.

43. A home agent of a communication node in a data communication system in which a mobile node which is connected to a first network and a communication node which is a communication partner of said mobile node and which is connected to a second network make communication with each other through a plurality of relay nodes located within an internetwork including the first network, the second network, a first home network which is a home network of said mobile node containing a home agent of said mobile node and a second home network which is a home network of said communication node containing a home agent of said communication node, the home agent of said communication node being used for a node discovery method of discovering a processing node which is, of said plurality of relay nodes, a relay node positioned on a direct path between said mobile node and said communication node, comprising:
reception means for receiving a message for the discovery of said processing node, transmitted from said mobile node or a predetermined node in the first network with which said mobile node is in connection; and
said transmission means for transferring the received message toward said communication node or a predetermined node in the second network with said communication node is in connection,
wherein said transmission means transmits the information on said relay node capable of becoming said processing node, received through said reception means, to said mobile node or said predetermined node in the first network with which said mobile node is in connection.

44. The home agent according to claim 41, further comprising judgment means for making a judgment on the basis of the received first message or the message as to whether or not the first network is the same as the second network, wherein, in a case in which the judgment in said judgment means shows that the first network is the same as the second network, the home agent determines that the home agent itself becomes the processing node or specifies a predetermined node as said processing node.

45. A relay node in a data communication system in which a mobile node which is connected to a first network and a communication node which is a communication partner of said mobile node and which is connected to a second network make communication with each other through a plurality of relay nodes located within an internetwork including the first network, the second network, a first home network which is a home network of said mobile node containing a home agent of said mobile node and a second home network which is a home network of said communication node containing a home agent of said communication node, the relay node being used for a node discovery method of discovering a processing node which is, of said plurality of relay nodes, a relay node positioned on a direct path between said mobile node and said communication node, comprising:
reception means for receiving a message for the discovery of said processing node from said communication node or a predetermined node in the second network with which said communication node is in connection;
judgment means for making a judgment on the basis of the received message as to whether or not the replay node itself is capable of becoming said processing node; and
transmission means for, when the judgment shows that the replay node itself is capable of becoming said processing node, transmitting information on the relay node itself to said home agent of said communication node.

46. The relay node according to claim 45, wherein, in a case in which the judgment in said judgment means shows that the relay node itself is capable of becoming said processing node and when said judgment means makes a judgment as to whether or not a different node capable of becoming said processing node exists between the relay node itself and a node which is a destination of the message and judges that it exists, said transmission means appends information on the relay node itself to the message and transfers the message.

47. A relay node in a data communication system in which a mobile node which is connected to a first network and a communication node which is a communication partner of said mobile node and which is connected to a second network make communication with each other through a plurality of relay nodes located within an internetwork including the first network, the second network, a first home network which is a home network of said mobile node containing a home agent of said mobile node and a second home network which is a home network of said communication node containing a home agent of said communication node, the relay node being used for a node discovery method of discovering a processing node which is, of said plurality of relay nodes, a relay node positioned on a direct path between said mobile node and said communication node, comprising:
reception means for, when a direction of data traffic is from said mobile node to said communication node, receiving a third message for the discovery of said processing node from said mobile node or a predetermined node in the first network with which said mobile node is in connection;
judgment means for making a judgment on the basis of the received third message as to whether or not the relay node itself is capable of becoming said processing node; and
transmission means for, when the judgment shows that it is capable of becoming said processing node, transmitting information on the relay node itself to said home agent of said mobile node.
